(19) United States
(12) Patent Application Publication
(10) Pub. No.: US 2025/0158896 A1
(43) Pub. Date: May 15, 2025

(54) ARTIFICIAL INTELLIGENCE MODEL PROCESSING METHOD AND RELATED DEVICE

(71) Applicant: HUAWEI TECHNOLOGIES CO., LTD., Shenzhen (CN)

(72) Inventors: Jian WANG, Hangzhou (CN); Rong LI, Boulogne Billancourt (FR); Gongzheng ZHANG, Hangzhou (CN); Wen TONG, Ottawa (CA); Jianglei MA, Ottawa (CA)

(21) Appl. No.: 19/026,918

(22) Filed: Jan. 17, 2025

Related U.S. Application Data
(63) Continuation of application No. PCT/CN2022/110616, filed on Aug. 5, 2022.

(51) Int. Cl. H04L 41/16; H04W 24/02

(52) U.S. Cl. CPC H04L 41/16; H04W 24/02

(57) ABSTRACT

In an artificial intelligence (AI) model processing method, a first node determines a first AI model, and the first node sends first information, where the first information indicates model information of the first AI model and auxiliary information of the first AI model. Compared with a manner in which different nodes exchange only respective AI models, in addition to the model information of the first AI model, the first information may further indicate the auxiliary information of the first AI model, so that a receiver of the first information can perform AI model processing (for example, training and merging) on the model information of the first AI model based on the auxiliary information of the first AI model, thereby improving performance of an AI model obtained by the receiver of the first information by performing processing based on the first AI model.

### CROSS-REFERENCE TO RELATED APPLICATIONS

This application is a continuation of International Application No. PCT/CN2022/110616, filed on Aug. 5, 2022, the disclosure of which is hereby incorporated by reference in its entirety.

### TECHNICAL FIELD

This disclosure relates to the communication field, and in particular to an artificial intelligence (AI) model processing method and a related device.

### BACKGROUND

Federated learning (FL) is widely used as a typical AI data processing mode. In a federated learning system, a central node performs model merging. Therefore, the federated learning system is generally of a star structure, and has a problem of poor robustness. Once the central node is faulty (for example, the central node is attacked), the entire system is paralyzed.

Currently, a decentralized AI data processing mode is an improvement to the federated learning AI data processing mode. In this mode, no central node needs to be set, and system robustness can be improved. In a decentralized system, after training a local AI model by using local data and a local target, each node exchanges an AI model with a neighboring node that is reachable in communication, and further processes (for example, trains and merges) a local AI model based on the exchanged AI model.

However, in the foregoing decentralized system, because there is no unified scheduling of the central node, how to implement AI model processing in the case that different distributed nodes receive an AI model from another node is an urgent technical problem to be resolved.

### SUMMARY

This disclosure provides an AI model processing method and a related device to improve performance of an AI model.

A first aspect of this disclosure provides an AI model processing method. The method is performed by a first node, or the method is performed by some components (for example, a processor, a chip, and a chip system) in a first node, or the method may be implemented by a logical module or software that can implement all or some functions of a first node. In the first aspect and a possible implementation of the first aspect, an example in which the method is performed by the first node is used for description. The first node may be a terminal device or a network device. In the method, the first node determines a first AI model; and the first node sends first information, where the first information indicates model information of the first AI model and auxiliary information of the first AI model.

Based on the foregoing technical solution, after the first node determines the first AI model, the first node sends the first information indicating the model information of the first AI model and the auxiliary information of the first AI model. Compared with a manner in which different nodes exchange only respective AI models, in addition to the model information of the first AI model, the first information may further indicate the auxiliary information of the first AI model, so that a receiver of the first information can perform AI model processing (for example, training and merging) on the model information of the first AI model based on the auxiliary information of the first AI model, thereby improving performance of an AI model obtained by the receiver of the first information by performing processing based on the first AI model.

In some embodiments, the auxiliary information of the first AI model includes at least one of the following: type information of the first AI model, identification information of the first node, identification information of a receiving node of the first AI model, version information of the first AI model, time information for generating the first AI model, geographical location information for generating the first AI model, and distribution information of local data of the first node.

Based on the foregoing technical solution, the auxiliary information of the first AI model indicated by the first information includes at least one of the foregoing information, so that the receiver of the first information can perform AI model processing on the model information of the first AI model based on the at least one of the foregoing information, thereby improving performance of the AI model obtained by the receiver of the first information by performing processing based on the first AI model.

In some embodiments, the model information of the first AI model and the auxiliary information of the first AI model are separately carried on different transmission resources, and the transmission resources include a time domain resource and/or a frequency domain resource.

Based on the foregoing technical solution, because a data volume corresponding to the model information of the first AI model and a data volume corresponding to the auxiliary information of the first AI model are generally different (for example, the data volume corresponding to the model information of the first AI model is generally greater than the data volume corresponding to the auxiliary information of the first AI model), so that the two can be separately carried on different transmission resources.

Optionally, the transmission resources are preconfigured resources.

In some embodiments, the first AI model is obtained based on a node type of the first node.

Based on the foregoing technical solution, the first AI model indicated by the first information sent by the first node may be a model obtained by the first node based on the node type of the first node. When the first AI model is obtained based on at least the node type of the first node, the first node can perform different AI model processing processes based on different node types to resolve a problem of a single node function, thereby improving flexibility.

In some embodiments, the first AI model is obtained based on a second AI model and the node type of the first node; the second AI model is obtained based on the local data; or the second AI model is obtained based on K pieces of information, each of the K pieces of information indicates model information of an AI model of another node and auxiliary information of the AI model of the another node, and K is a positive integer; or the second AI model is obtained based on the local data and the K pieces of information.

Based on the foregoing technical solution, when the first AI model is obtained based on at least the second AI model, the first AI model indicated by the first information sent by the first node may be a model that can be understood by the another node, so that the another node performs further model processing after receiving the first AI model. In addition, the second AI model used to obtain the first AI model may be any one of the foregoing implementations to improve solution implementation flexibility.

In some embodiments, the node type includes any one of the following: a node type of performing local training based on the local data, a node type of performing merging processing based on the AI model of the another node, and a node type of performing local training based on the local data and performing merging processing based on the AI model of the another node.

Based on the foregoing technical solution, the node type used to obtain the first AI model may be any one of the foregoing implementations to improve the solution implementation flexibility.

In some embodiments, the method further includes: The first node sends indication information indicating the node type of the first node.

Based on the foregoing technical solution, the first node may further send the indication information indicating the node type of the first node, so that the another node clearly determines the node type of the first node based on the indication information, and can subsequently interact with the first node based on the node type of the first node.

In some embodiments, the method further includes: The first node determines the node type of the first node based on capability information and/or requirement information; or the first node receives the indication information indicating the node type of the first node.

Based on the foregoing technical solution, the first node may clearly determine the node type of the first node based on the capability information and/or the requirement information of the first node, or may clearly determine the node type of the first node based on an indication of the another node, to improve the solution implementation flexibility.

In some embodiments, the first AI model is a model that can be understood by M nodes in a system in which the first node is located, and M is an integer greater than or equal to 2.

In some embodiments, the first AI model is a model that can be understood by the M nodes in the system in which the first node is located. This may be expressed as that the first AI model is a model common to the M nodes in the system in which the first node is located. A model structure of the first AI model is a model structure that can be understood by the M nodes in the system in which the first node is located, a model structure of the first AI model is a model structure common to the M nodes in the system in which the first node is located, the first AI model is a public model of the system in which the first node is located, or a model structure of the first AI model is a public model structure of the system in which the first node is located.

Based on the foregoing technical solution, the first AI model indicated by the first information sent by the first node is a model that can be understood by the M nodes in the system in which the first node is located, so that when the M nodes are of a plurality of different node types, the another node can understand the first AI model and further perform model processing after receiving the first information.

A second aspect of this disclosure provides an AI model processing method. The method is performed by a second node, or the method is performed by some components (for example, a processor, a chip, and a chip system) in a second node, or the method may be implemented by a logical module or software that can implement all or some functions of a second node. In the second aspect and a possible implementation of the second aspect, an example in which the method is performed by the second node is used for description. The second node may be a terminal device or a network device. In the method, the second node receives N pieces of first information from N first nodes, where each of the N pieces of first information indicates model information of a first AI model and auxiliary information of the first AI model, and N is a positive integer; and the second node performs model processing based on the N pieces of first information to obtain a target AI model.

Based on the foregoing technical solution, each of the N pieces of first information received by the second node indicates the model information of the first AI model and the auxiliary information of the first AI model. Then, the second node performs model processing based on the N pieces of first information to obtain the target AI model. Compared with a manner in which different nodes exchange only respective AI models, in addition to the model information of the first AI model, each piece of first information may further indicate the auxiliary information of the first AI model, so that the second node can perform AI model processing (for example, training and merging) on the model information of the first AI model based on the auxiliary information of the first AI model, thereby improving performance of an AI model obtained by the second node by performing processing based on the first AI model.

Optionally, the target AI model is used to complete an AI task of the second node, or the target AI model is a local model of the second node.

In some embodiments, the auxiliary information of the first AI model includes at least one of the following: type information of the first AI model, identification information of the first node, identification information of a receiving node of the first AI model, version information of the first AI model, time information for generating the first AI model, geographical location information for generating the first AI model, and distribution information of local data of the first node.

Based on the foregoing technical solution, the auxiliary information of the first AI model indicated by the first information includes at least one of the foregoing information, so that the second node can perform AI model processing on the model information of the first AI model based on the at least one of the foregoing information, thereby improving performance of the AI model obtained by the second node by performing processing based on the first AI model.

In some embodiments, the model information of the first AI model and the auxiliary information of the first AI model are separately carried on different transmission resources, and the transmission resources include a time domain resource and/or a frequency domain resource.

Based on the foregoing technical solution, because a data volume corresponding to the model information of the first AI model and a data volume corresponding to the auxiliary information of the first AI model are generally different (for example, the data volume corresponding to the model information of the first AI model is generally greater than the data volume corresponding to the auxiliary information of the first AI model), so that the two can be separately carried on different transmission resources.

Optionally, the transmission resources are preconfigured resources.

In some embodiments, that the second node performs model processing based on the N pieces of first information to obtain a target AI model includes: The second node performs model processing based on the N pieces of first information and a node type of the second node to obtain the target AI model.

Based on the foregoing technical solution, the target AI model obtained by the second node by performing model processing may be a model obtained by the second node based on at least the node type of the second node. When the target AI model is obtained based on at least the node type of the second node, the second node can perform different AI model processing processes based on different node types to resolve a problem of a single node function, thereby improving flexibility.

In some embodiments, that the second node performs model processing based on the N pieces of first information and a node type of the second node to obtain the target AI model includes: When the node type of the second node is a node type of performing merging processing based on an AI model of another node, the second node performs model merging on N first AI models based on the N pieces of first information to obtain the target AI model.

Based on the foregoing technical solution, when the node type of the second node is the node type of performing merging processing based on the AI model of the another node, after the second node receives the N pieces of first information and determines the N first AI models, the second node performs model merging on the N first AI models to obtain the target AI model.

In some embodiments, that the second node performs model processing based on the N pieces of first information and a node type of the second node to obtain the target AI model includes: When the node type of the second node is a node type of performing local training based on the local data and performing merging processing based on the AI model of the another node, the second node performs model merging on the N first AI models and a second AI model based on the N pieces of first information to obtain the target AI model, where the second AI model is obtained through training based on the local data.

Based on the foregoing technical solution, when the node type of the second node is the node type of performing local training based on the local data and performing merging processing based on the AI model of the another node, after the second node receives the N pieces of first information and determines the N first AI models, the second node needs to perform training based on the local data to obtain the second AI model, and performs model merging on the N first AI models and the second AI model to obtain the target AI model.

In some embodiments, the method further includes: The second node receives indication information indicating a node type of the first node.

Based on the foregoing technical solution, the second node may further receive the indication information indicating the node type of the first node, so that the second node clearly determines the node type of the first node based on the indication information. Subsequently, the second node can interact with the first node based on the node type of the first node.

In some embodiments, the method further includes: The second node sends indication information indicating the node type of the second node.

Based on the foregoing technical solution, the second node may further send the indication information indicating the node type of the second node, so that the another node clearly determines the node type of the second node based on the indication information, and can subsequently interact with the second node based on the node type of the second node.

In some embodiments, the method further includes: The second node determines the node type of the second node based on capability information and/or requirement information; or the second node receives the indication information indicating the node type of the second node.

Based on the foregoing technical solution, the second node may clearly determine the node type of the second node based on the capability information and/or the requirement information of the second node, or may clearly determine the node type of the second node based on an indication of the another node, to improve the solution implementation flexibility.

In some embodiments, the first AI model is a model that can be understood by M nodes in a system in which the second node is located, and M is an integer greater than or equal to 2

In some embodiments, the first AI model is a model that can be understood by the M nodes in the system in which the second node is located. This may be expressed as that the first AI model is a model common to the M nodes in the system in which the second node is located. A model structure of the first AI model is a model structure that can be understood by the M nodes in the system in which the second node is located, a model structure of the first AI model is a model structure common to the M nodes in the system in which the second node is located, the first AI model is a public model of the system in which the second node is located, or a model structure of the first AI model is a public model structure of the system in which the second node is located.

Based on the foregoing technical solution, the first AI model indicated by each of the N pieces of first information received by the second node is a model that can be understood by the M nodes in the system in which the second node is located, so that when the M nodes are of a plurality of different node types, each node can understand the first AI model and further perform model processing after receiving the first information.

A third aspect of this disclosure provides an AI model processing method. The method is performed by a first node, or the method is performed by some components (for example, a processor, a chip, and a chip system) in a first node, or the method may be implemented by a logical module or software that can implement all or some functions of a first node. In the third aspect and a possible implementation of the third aspect, an example in which the method is performed by the first node is used for description. The first node may be a terminal device or a network device. In the method, the first node obtains a local AI model, where the local AI model is used to complete an AI task of the first node; the first node determines a public AI model based on the local AI model, where the public AI model is a model that can be understood by M nodes in a system in which the first node is located, and M is an integer greater than or equal to 2; and the first node sends first information, where the first information indicates model information of the public AI model.

Based on the foregoing technical solution, the first node obtains the local AI model used to complete the AI task of the first node. The first node determines the public AI model based on the local AI model. The first node sends the first information indicating the model information of the public AI model. The public AI model is a model that can be understood by the M nodes in the system in which the first node is located. In other words, the public AI model indicated by the first information sent by the first node is a model that can be understood by the M nodes in the system in which the first node is located, so that when the M nodes are of a plurality of different node types, another node can understand the public AI model and further perform model processing after receiving the first information.

In some embodiments, the public AI model is a model that can be understood by the M nodes in the system in which the first node is located. This may be expressed as that the public AI model is a model common to the M nodes in the system in which the first node is located, a model structure of the public AI model is a model structure that can be understood by the M nodes in the system in which the first node is located, or a model structure of the public AI model is a model structure common to the M nodes in the system in which the first node is located.

In some embodiments, that the first node determines the public AI model based on the local AI model includes: The first node determines the public AI model based on the local AI model and a node type of the first node.

Based on the foregoing technical solution, the first node may determine the public AI model based on the local AI model and the node type of the first node, so that the first node can perform different AI model processing processes based on different node types to resolve a problem of a single node function, thereby improving flexibility.

In some embodiments, the node type includes any one of the following: a node type of performing local training based on local data, a node type of performing merging processing based on an AI model of the another node, and a node type of performing local training based on the local data and performing merging processing based on the AI model of the another node.

Based on the foregoing technical solution, the node type used to obtain the public AI model may be any one of the foregoing implementations to improve the solution implementation flexibility.

In some embodiments, the method further includes: The first node sends indication information indicating the node type of the first node.

Based on the foregoing technical solution, the first node may further send the indication information indicating the node type of the first node, so that the another node clearly determines the node type of the first node based on the indication information, and can subsequently interact with the first node based on the node type of the first node.

In some embodiments, the method further includes: The first node determines the node type of the first node based on capability information and/or requirement information; or the first node receives the indication information indicating the node type of the first node.

Based on the foregoing technical solution, the first node may clearly determine the node type of the first node based on the capability information and/or the requirement information of the first node, or may clearly determine the node type of the first node based on an indication of the another node, to improve the solution implementation flexibility.

In some embodiments,
the local AI model is obtained based on the local data; or
the local AI model is obtained based on K pieces of information, each of the K pieces of information indicates model information of an AI model of another node and auxiliary information of the AI model of the another node, and K is a positive integer; or
the local AI model is obtained based on the local data and the K pieces of information.

Based on the foregoing technical solution, the local AI model used to obtain the public AI model may be any one of the foregoing implementations to improve the solution implementation flexibility.

In some embodiments, the first information further indicates auxiliary information of the public AI model.

Based on the foregoing technical solution, the first information sent by the first node further indicates the auxiliary information of the public AI model. Compared with a manner in which different nodes exchange only respective AI models, in addition to the model information of the public AI model, the first information may further indicate the auxiliary information of the public AI model, so that a receiver of the first information can perform AI model processing (for example, training and merging) on the model information of the public AI model based on the auxiliary information of the public AI model, thereby improving performance of an AI model obtained by the receiver of the first information by performing processing based on the public AI model.

In some embodiments, the auxiliary information of the public AI model includes at least one of the following: type information of the public AI model, identification information of the first node, identification information of a receiving node of the public AI model, version information of the public AI model, time information for generating the public AI model, geographical location information for generating the public AI model, and distribution information of the local data of the first node.

Based on the foregoing technical solution, the auxiliary information of the public AI model indicated by the first information includes at least one of the foregoing information, so that the receiver of the first information can perform AI model processing on the model information of the public AI model based on the at least one of the foregoing information, thereby improving performance of the AI model obtained by the receiver of the first information by performing processing based on the public AI model.

In some embodiments, the model information of the public AI model and the auxiliary information of the public AI model are separately carried on different transmission resources, and the transmission resources include a time domain resource and/or a frequency domain resource.

Based on the foregoing technical solution, because a data volume corresponding to the model information of the public AI model and a data volume corresponding to the auxiliary information of the public AI model are generally different (for example, the data volume corresponding to the model information of the public AI model is generally greater than the data volume corresponding to the auxiliary information of the public AI model), so that the two can be separately carried on different transmission resources.

A fourth aspect of this disclosure provides an AI model processing method. The method is performed by a second node, or the method is performed by some components (for example, a processor, a chip, and a chip system) in a second node, or the method may be implemented by a logical module or software that can implement all or some functions of a second node. In the fourth aspect and a possible implementation of the fourth aspect, an example in which the method is performed by the second node is used for description. The second node may be a terminal device or a network device. In the method, the second node receives N pieces of first information, where each of the N pieces of first information indicates model information of a public AI model, the public AI model is a model that can be understood by M nodes in a system in which the second node is located, and M is an integer greater than or equal to 2; and the second node updates a local AI model based on the N pieces of first information to obtain an updated local AI model, where the local AI model is used to complete an AI task of the second node.

Based on the foregoing technical solution, each of the N pieces of first information received by the second node indicates the model information of the public AI model. Then, the second node updates the local AI model based on the N pieces of first information to obtain the updated local AI model. The public AI model is a model that can be understood by the M nodes in the system in which the second node is located. In other words, the public AI model indicated by the first information received by the second node is a model that can be understood by the M nodes in the system in which the second node is located, so that when the M nodes are of a plurality of different node types, another node can understand the public AI model and further perform model processing after receiving the first information.

In some embodiments, the public AI model is a model that can be understood by the M nodes in the system in which the second node is located. This may be expressed as that the public AI model is a model common to the M nodes in the system in which the second node is located, a model structure of the public AI model is a model structure that can be understood by the M nodes in the system in which the second node is located, or a model structure of the public AI model is a model structure common to the M nodes in the system in which the second node is located.

In some embodiments, a process in which the second node updates the local AI model based on the N pieces of first information to obtain the updated local AI model includes: The second node updates the local AI model based on the N pieces of first information and a node type of the second node to obtain the updated local AI model.

Based on the foregoing technical solution, the second node may determine the public AI model based on the N pieces of first information and the node type of the second node, so that the second node can perform different AI model processing processes based on different node types, to resolve a problem of a single node function, thereby improving the flexibility.

In some embodiments, the node type includes any one of the following: a node type of performing merging processing based on an AI model of the another node and a node type of performing local training based on a local data and performing merging processing based on the AI model of the another node.

Based on the foregoing technical solution, the node type used to obtain the updated local AI model may be any one of the foregoing implementations to improve the solution implementation flexibility.

In some embodiments, the method further includes: The second node sends indication information indicating the node type of the second node.

Based on the foregoing technical solution, the second node may further send the indication information indicating the node type of the second node, so that the another node clearly determines the node type of the second node based on the indication information, and can subsequently interact with the second node based on the node type of the second node.

In some embodiments, the method further includes: The second node determines the node type of the second node based on capability information and/or requirement information; or the second node receives the indication information indicating the node type of the second node.

Based on the foregoing technical solution, the second node may clearly determine the node type of the second node based on the capability information and/or the requirement information of the second node, or may clearly determine the node type of the second node based on an indication of the another node, to improve the solution implementation flexibility.

In some embodiments, when the node type is the node type of performing merging processing based on the AI model of the another node, the local AI model is obtained based on P pieces of information, each of the P pieces of information indicates model information of the AI model of the another node and auxiliary information of the AI model of the another node, and P is a positive integer.

In some embodiments, when the node type is the node type of performing local training based on the local data and performing merging processing based on the AI model of the another node, the local AI model is obtained based on the local data, or the local AI model is obtained based on the local data and the P pieces of information, each of the P pieces of information indicates the model information of the AI model of the another node and the auxiliary information of the AI model of the another node, and P is a positive integer.

Based on the foregoing technical solution, when the node types are different, the local AI model may be the foregoing different implementations to improve the solution implementation flexibility.

In some embodiments, the first information further indicates auxiliary information of the public AI model.

Based on the foregoing technical solution, each piece of first information received by the second node further indicates the auxiliary information of the public AI model. Compared with a manner in which different nodes exchange only respective AI models, in addition to model information of the public AI model, the first information may further indicate the auxiliary information of the public AI model, so that the second node can update the local AI model based on the auxiliary information of the public AI model to obtain the updated local AI model, thereby improving performance of an AI model obtained by the second node by performing processing based on the public AI model.

In some embodiments, the auxiliary information of the public AI model includes at least one of the following: type information of the public AI model, identification information of the first node, identification information of a receiving node of the public AI model, version information of the public AI model, time information for generating the public AI model, geographical location information for generating the public AI model, and distribution information of the local data of the first node.

Based on the foregoing technical solution, the auxiliary information of the public AI model indicated by the first information includes at least one of the foregoing information, so that the second node can perform AI model processing on the model information of the public AI model based on the at least one of the foregoing information, thereby improving performance of the AI model obtained by the second node by performing processing based on the public AI model.

In some embodiments, the model information of the public AI model and the auxiliary information of the public AI model are separately carried on different transmission resources, and the transmission resources include a time domain resource and/or a frequency domain resource.

Based on the foregoing technical solution, because a data volume corresponding to the model information of the public AI model and a data volume corresponding to the auxiliary information of the public AI model are generally different (for example, the data volume corresponding to the model information of the public AI model is generally greater than the data volume corresponding to the auxiliary information of the public AI model), so that the two can be separately carried on different transmission resources.

A fifth aspect of this disclosure provides an AI model processing method. The method is performed by a first node, or the method is performed by some components (for example, a processor, a chip, and a chip system) in a first node, or the method may be implemented by a logical module or software that can implement all or some functions of a first node. In the fifth aspect and a possible implementation of the fifth aspect, an example in which the method is performed by the first node is used for description. The first node may be a terminal device or a network device. In the method, the first node determines a node type of the first node.

Based on the foregoing technical solution, the first node may determine the node type of the first node. Subsequently, the first node may perform AI model processing based on the node type. In this way, the first node can perform different AI model processing processes based on different node types to resolve a problem of a single node function, thereby improving flexibility.

In some embodiments, the first node sends indication information indicating the node type of the first node.

Based on the foregoing technical solution, the first node may further send the indication information indicating the node type of the first node, so that another node clearly determines the node type of the first node based on the indication information, and can subsequently interact with the first node based on the node type of the first node.

In some embodiments, the method further includes: The first node sends first information, where the first information indicates model information of a first AI model, and the first AI model is obtained based on the node type of the first node.

Based on the foregoing technical solution, the first AI model indicated by the first information sent by the first node may be a model obtained by the first node based on the node type of the first node. When the first AI model is obtained based on at least the node type of the first node, the first node can perform different AI model processing processes based on different node types to resolve a problem of a single node function, thereby improving the flexibility.

In some embodiments, the first AI model is obtained based on a second AI model and the node type of the first node.

Based on the foregoing technical solution, when the first AI model is obtained based on at least the second AI model, the first AI model indicated by the first information sent by the first node may be a model that can be understood by the another node, so that the another node performs further model processing after receiving the first AI model.

In some embodiments,
the second AI model is obtained based on local data; or
the second AI model is obtained based on K pieces of information, each of the K pieces of information indicates model information of an AI model of the another node and auxiliary information of the AI model of the another node, and K is a positive integer; or
the second AI model is obtained based on the local data and the K pieces of information.

Based on the foregoing technical solution, the second AI model used to obtain the first AI model may be any one of the foregoing implementations to improve the solution implementation flexibility.

In some embodiments, the node type includes any one of the following: a node type of performing local training based on the local data, a node type of performing merging processing based on the AI model of the another node, and a node type of performing local training based on the local data and performing merging processing based on the AI model of the another node.

Based on the foregoing technical solution, the node type used to obtain the first AI model may be any one of the foregoing implementations to improve the solution implementation flexibility.

In some embodiments, the first information further indicates auxiliary information of the first AI model.

Based on the foregoing technical solution, the first information sent by the first node further indicates the auxiliary information of the first AI model. Compared with a manner in which different nodes exchange only respective AI models, in addition to the model information of the first AI model, the first information may further indicate the auxiliary information of the first AI model, so that a receiver of the first information can perform AI model processing (for example, training and merging) on the model information of the first AI model based on the auxiliary information of the first AI model, thereby improving performance of an AI model obtained by the receiver of the first information by performing processing based on the first AI model.

In some embodiments, the auxiliary information of the first AI model includes at least one of the following: type information of the first AI model, identification information of the first node, identification information of a receiving node of the first AI model, version information of the first AI model, time information for generating the first AI model, geographical location information for generating the first AI model, and distribution information of the local data of the first node.

Based on the foregoing technical solution, the auxiliary information of the first AI model indicated by the first information includes at least one of the foregoing information, so that the receiver of the first information can perform AI model processing on the model information of the first AI model based on the at least one of the foregoing information, thereby improving performance of the AI model obtained by the receiver of the first information by performing processing based on the first AI model.

In some embodiments, the model information of the first AI model and the auxiliary information of the first AI model are separately carried on different transmission resources, and the transmission resources include a time domain resource and/or a frequency domain resource.

Based on the foregoing technical solution, because a data volume corresponding to the model information of the public AI model and a data volume corresponding to the auxiliary information of the public AI model are generally different (for example, the data volume corresponding to the model information of the public AI model is generally greater than the data volume corresponding to the auxiliary information of the public AI model), so that the two can be separately carried on different transmission resources.

In some embodiments, the first AI model is a model that can be understood by M nodes in a system in which the first node is located, and M is an integer greater than or equal to 2.

Based on the foregoing technical solution, the first AI model indicated by the first information sent by the first node is a model that can be understood by the M nodes in the system in which the first node is located, so that when the M nodes are of a plurality of different node types, the another node can understand the first AI model and further perform model processing after receiving the first information.

In some embodiments, the method further includes: The first node determines the node type of the first node based on capability information and/or requirement information; or the first node receives the indication information indicating the node type of the first node.

Based on the foregoing technical solution, the first node may clearly determine the node type of the first node based on the capability information and/or the requirement information of the first node, or may clearly determine the node type of the first node based on an indication of the another node, to improve the solution implementation flexibility.

A sixth aspect of this disclosure provides an AI model processing method. The method is performed by a second node, or the method is performed by some components (for example, a processor, a chip, and a chip system) in a second node, or the method may be implemented by a logical module or software that can implement all or some functions of a second node. In the sixth aspect and a possible implementation of the sixth aspect, an example in which the method is performed by the second node is used for description. The second node may be a terminal device or a network device. In the method, the second node receives indication information indicating a node type of the first node; and/or the second node receives first information, where the first information indicates model information of the first AI model, and the first AI model is obtained based on the node type of the first node.

Based on the foregoing technical solution, when the second node receives the indication information indicating the node type of the first node, the second node clearly determines the node type of the first node based on the indication information. Subsequently, the second node can interact with the first node based on the node type of the first node.

In addition, when the second node receives the first information indicating the model information of the first AI model, the first AI model is obtained based on the node type of the first node. When the first AI model is obtained based on at least the node type of the first node, the first node can perform different AI model processing processes based on different node types to resolve a problem of a single node function, thereby improving flexibility.

In some embodiments, the first AI model is obtained based on the node type of the first node and a second AI model.

Based on the foregoing technical solution, when the first AI model is obtained based on at least the second AI model, the first AI model received by the second node may be a model that can be understood by another node other than the first node, so that the another node (for example, the second node) subsequently performs further model processing after receiving a target AI model.

In some embodiments,
the second AI model is obtained based on local data; or
the second AI model is obtained based on K pieces of information, each of the K pieces of information indicates model information of an AI model of the another node and auxiliary information of the AI model of the another node, and K is a positive integer; or
the second AI model is obtained based on the local data and the K pieces of information.

Based on the foregoing technical solution, the second AI model used to obtain the first AI model may be any one of the foregoing implementations to improve the solution implementation flexibility.

In some embodiments, the node type of the first node includes any one of the following: a node type of performing local training based on the local data, a node type of performing merging processing based on the AI model of the another node, and a node type of performing local training based on the local data and performing merging processing based on the AI model of the another node.

Based on the foregoing technical solution, the node type used to obtain the first AI model may be any one of the foregoing implementations to improve the solution implementation flexibility.

Optionally, a node type of the second node includes any one of the following: a node type of performing merging processing based on the AI model of the another node and a node type of performing local training based on the local data and performing merging processing based on the AI model of the another node.

In some embodiments, the first information further indicates auxiliary information of the first AI model.

Based on the foregoing technical solution, the first information received by the second node further indicates the auxiliary information of the first AI model. Compared with a manner in which different nodes exchange only respective AI models, in addition to the model information of the first AI model, the first information may further indicate the auxiliary information of the first AI model, so that the second node can perform AI model processing (for example, training and merging) on the model information of the first AI model based on the auxiliary information of the first AI model, thereby improving performance of an AI model obtained by the second node by performing processing based on the first AI model.

In some embodiments, the auxiliary information of the first AI model includes at least one of the following: type information of the first AI model, identification information of the first node, identification information of a receiving node of the first AI model, version information of the first AI model, time information for generating the first AI model, geographical location information for generating the first AI model, and distribution information of the local data of the first node.

Based on the foregoing technical solution, the auxiliary information of the first AI model indicated by the first information includes at least one of the foregoing information, so that a receiver of the first information can perform AI model processing on the model information of the first AI model based on the at least one of the foregoing information, thereby improving performance of the AI model obtained by the receiver of the first information by performing processing based on the first AI model.

In some embodiments, the model information of the first AI model and the auxiliary information of the first AI model are separately carried on different transmission resources, and the transmission resources include a time domain resource and/or a frequency domain resource.

Based on the foregoing technical solution, because a data volume corresponding to model information of a public AI model and a data volume corresponding to auxiliary information of the public AI model are generally different (for example, the data volume corresponding to the model information of the public AI model is generally greater than the data volume corresponding to the auxiliary information of the public AI model), so that the two can be separately carried on different transmission resources.

In some embodiments, the first AI model is a model that can be understood by M nodes in a system in which the first node is located, and M is an integer greater than or equal to 2.

Based on the foregoing technical solution, the first AI model indicated by the first information received by the second node is a model that can be understood by M nodes in a system in which the second node is located, so that when the M nodes are of a plurality of different node types, the another node can understand the first AI model and further perform model processing after receiving the first information.

In some embodiments, the method further includes: The second node determines the node type of the second node based on capability information and/or requirement information; or the first node receives the indication information indicating the node type of the second node.

Based on the foregoing technical solution, the second node may clearly determine the node type of the second node based on the capability information and/or the requirement information of the second node, or may clearly determine the node type of the second node based on an indication of the another node, to improve the solution implementation flexibility.

A seventh aspect of this disclosure provides an AI model processing apparatus. The apparatus is a first node, or the apparatus is some components (for example, a processor, a chip, or a chip system) in a first node, or the apparatus may be a logical module or software that can implement all or some functions of a first node. In the seventh aspect and a possible implementation of the seventh aspect, an example in which the communication apparatus is the first node is used for description. The first node may be a terminal device or a network device.

The apparatus includes a processing unit and a transceiver unit. The processing unit is configured to determine a first AI model. The transceiver unit is configured to send first information, where the first information indicates model information of the first AI model and auxiliary information of the first AI model.

In some embodiments, the auxiliary information of the first AI model includes at least one of the following:
type information of the first AI model, identification information of the first node, identification information of a receiving node of the first AI model, version information of the first AI model, time information for generating the first AI model, geographical location information for generating the first AI model, and distribution information of local data of the first node.

In some embodiments, the model information of the first AI model and the auxiliary information of the first AI model are separately carried on different transmission resources, and the transmission resources include a time domain resource and/or a frequency domain resource.

In some embodiments, the first AI model is obtained based on a node type of the first node.

In some embodiments, the first AI model is obtained based on a second AI model and the node type of the first node.

In some embodiments, the second AI model is obtained based on the local data; or the second AI model is obtained based on K pieces of information, each of the K pieces of information indicates model information of an AI model of another node and auxiliary information of the AI model of the another node, and K is a positive integer; or the second AI model is obtained based on the local data and the K pieces of information.

In some embodiments, the node type includes any one of the following: a node type of performing local training based on the local data, a node type of performing merging processing based on the AI model of the another node, and a node type of performing local training based on the local data and performing merging processing based on the AI model of the another node.

In some embodiments, the transceiver unit is further configured to send indication information indicating the node type of the first node.

In some embodiments, the processing unit is further configured to determine the node type of the first node based on capability information and/or requirement information; or the transceiver unit is further configured to receive the indication information indicating the node type of the first node.

In some embodiments, the first AI model is a model that can be understood by M nodes in a system in which the first node is located, and M is an integer greater than or equal to 2.

In some embodiments, the composition modules of the communication apparatus may further be configured to: perform the steps performed in the possible implementations of the first aspect, and achieve corresponding technical effects. For details, refer to the first aspect.

An eighth aspect of this disclosure provides an AI model processing apparatus. The apparatus is a second node, or the apparatus is some components (for example, a processor, a chip, or a chip system) in a second node, or the apparatus may be a logical module or software that can implement all or some functions of a second node. In the eighth aspect and a possible implementation of the eighth aspect, an example in which the communication apparatus is the second node is used for description. The second node may be a terminal device or a network device.

The apparatus includes a processing unit and a transceiver unit. The transceiver unit is configured to receive N pieces of first information, where each of the N pieces of first information indicates model information of a first AI model and auxiliary information of the first AI model, and N is a positive integer. The processing unit is configured to perform model processing based on the N pieces of first information to obtain a target AI model.

Optionally, the target AI model is used to complete an AI task of the second node, or the target AI model is a local model of the second node.

In some embodiments, the auxiliary information of the first AI model includes at least one of the following:
type information of the first AI model, identification information of a first node, identification information of a receiving node of the first AI model, version information of the first AI model, time information for generating the first AI model, geographical location information for generating the first AI model, and distribution information of local data of the first node.

In some embodiments, the model information of the first AI model and the auxiliary information of the first AI model are separately carried on different transmission resources, and the transmission resources include a time domain resource and/or a frequency domain resource.

In some embodiments, the processing unit is specifically configured to perform model processing based on the N pieces of first information and a node type of the second node to obtain the target AI model.

In some embodiments, when the node type of the second node is a node type of performing merging processing based on an AI model of another node, the processing unit is specifically configured to perform model merging on N first AI models based on the N pieces of first information to obtain the target AI model.

In some embodiments, when the node type of the second node is a node type of performing local training based on the local data and performing merging processing based on the AI model of the another node, the processing unit is specifically configured to perform model merging on the N first AI models and a second AI model based on the N pieces of first information to obtain the target AI model, where the second AI model is obtained through training based on the local data.

In some embodiments, the transceiver unit is further configured to receive indication information indicating a node type of the first node.

In some embodiments, the transceiver unit is further configured to send indication information indicating the node type of the second node.

In some embodiments, the processing unit is further configured to determine the node type of the second node based on capability information and/or requirement information; or the transceiver unit is further configured to receive the indication information indicating the node type of the second node.

In some embodiments, the first AI model is a model that can be understood by M nodes in a system in which the second node is located, and M is an integer greater than or equal to 2.

In some embodiments, the composition modules of the communication apparatus may further be configured to: perform the steps performed in the possible implementations of the second aspect, and achieve corresponding technical effects. For details, refer to the second aspect.

A ninth aspect of this disclosure provides an AI model processing apparatus. The apparatus is a first node, or the apparatus is some components (for example, a processor, a chip, or a chip system) in a first node, or the apparatus may be a logical module or software that can implement all or some functions of a first node. In the ninth aspect and a possible implementation of the ninth aspect, an example in which the communication apparatus is the first node is used for description. The first node may be a terminal device or a network device.

The apparatus includes a processing unit and a transceiver unit. The processing unit is configured to obtain a local AI model, where the local AI model is used to complete an AI task of the first node. The processing unit is further configured to determine a public AI model based on the local AI model, where the public AI model is a model that can be understood by M nodes in a system in which the first node is located, and M is an integer greater than or equal to 2. The transceiver unit is configured to send first information, where the first information indicates model information of the public AI model.

In some embodiments, the processing unit is specifically configured to determine the public AI model based on the local AI model and a node type of the first node.

In some embodiments, the node type includes any one of the following: a node type of performing local training based on local data, a node type of performing merging processing based on an AI model of another node, and a node type of performing local training based on the local data and performing merging processing based on the AI model of the another node.

In some embodiments, the transceiver unit is further configured to send indication information indicating the node type of the first node.

In some embodiments, the processing unit is further configured to determine the node type of the first node based on capability information and/or requirement information; or the transceiver unit is further configured to receive the indication information indicating the node type of the first node.

In some embodiments,
the local AI model is obtained based on the local data; or
the local AI model is obtained based on K pieces of information, each of the K pieces of information indicates model information of an AI model of another node and auxiliary information of the AI model of the another node, and K is a positive integer; or
the local AI model is obtained based on the local data and the K pieces of information.

In some embodiments, the first information further indicates auxiliary information of the public AI model.

In some embodiments, the auxiliary information of the public AI model includes at least one of the following:
type information of the public AI model, identification information of the first node, identification information of a receiving node of the public AI model, version information of the public AI model, time information for generating the public AI model, geographical location information for generating the public AI model, and distribution information of the local data of the first node.

In some embodiments, the model information of the public AI model and the auxiliary information of the public AI model are separately carried on different transmission resources, and the transmission resources include a time domain resource and/or a frequency domain resource.

In some embodiments, the composition modules of the communication apparatus may further be configured to: perform the steps performed in the possible implementations of the third aspect, and achieve corresponding technical effects. For details, refer to the third aspect.

A tenth aspect of this disclosure provides an AI model processing apparatus. The apparatus is a second node, or the apparatus is some components (for example, a processor, a chip, or a chip system) in a second node, or the apparatus may be a logical module or software that can implement all or some functions of a second node. In the tenth aspect and a possible implementation of the tenth aspect, an example in which the communication apparatus is the second node is used for description. The second node may be a terminal device or a network device.

The apparatus includes a processing unit and a transceiver unit. The transceiver unit is configured to receive N pieces of first information, where each of the N pieces of first information indicates model information of a public AI model, the public AI model is a model that can be understood by M nodes in a system in which the second node is located, and M is an integer greater than or equal to 2. The processing unit is configured to update a local AI model based on the N pieces of first information to obtain an updated local AI model, where the local AI model is used to complete an AI task of the second node.

In some embodiments, the processing unit is specifically configured to update the local AI model based on the N pieces of first information and a node type of the second node to obtain the updated local AI model.

In some embodiments, the node type includes any one of the following: a node type of performing merging processing based on an AI model of another node and a node type of performing local training based on a local data and performing merging processing based on the AI model of the another node.

In some embodiments, the transceiver unit is further configured to send indication information indicating the node type of the second node.

In some embodiments, the processing unit is further configured to determine the node type of the second node based on capability information and/or requirement information; or the transceiver unit is further configured to receive the indication information indicating the node type of the second node.

In some embodiments, when the node type is the node type of performing merging processing based on the AI model of the another node, the local AI model is obtained based on P pieces of information, each of the P pieces of information indicates model information of the AI model of the another node and auxiliary information of the AI model of the another node, and P is a positive integer.

In some embodiments, when the node type is the node type of performing local training based on the local data and performing merging processing based on the AI model of the another node, the local AI model is obtained based on the local data, or the local AI model is obtained based on the local data and the P pieces of information, each of the P pieces of information indicates the model information of the AI model of the another node and the auxiliary information of the AI model of the another node, and P is a positive integer.

In some embodiments, the first information further indicates auxiliary information of the public AI model.

In some embodiments, the auxiliary information of the public AI model includes at least one of the following: type information of the public AI model, identification information of the first node, identification information of a receiving node of the public AI model, version information of the public AI model, time information for generating the public AI model, geographical location information for generating the public AI model, and distribution information of the local data of the first node.

In some embodiments, the model information of the public AI model and the auxiliary information of the public AI model are separately carried on different transmission resources, and the transmission resources include a time domain resource and/or a frequency domain resource.

In some embodiments, the composition modules of the communication apparatus may further be configured to: perform the steps performed in the possible implementations of the fourth aspect, and achieve corresponding technical effects. For details, refer to the fourth aspect.

An eleventh aspect of this disclosure provides an AI model processing apparatus. The apparatus is a first node, or the apparatus is some components (for example, a processor, a chip, or a chip system) in a first node, or the apparatus may be a logical module or software that can implement all or some functions of a first node. In the eleventh aspect and a possible implementation of the eleventh aspect, an example in which the communication apparatus is the first node is used for description. The first node may be a terminal device or a network device.

The apparatus includes a processing unit. The processing unit is used by the first node to determine a node type of the first node.

In some embodiments, the apparatus further includes a transceiver unit. The transceiver unit is configured to send indication information indicating the node type of the first node.

In some embodiments, the apparatus further includes a transceiver unit. The transceiver unit is configured to send first information, where the first information indicates model information of a first AI model, and the first AI model is obtained based on the node type of the first node.

Optionally, the first AI model is obtained based on a second AI model and the node type of the first node.

In some embodiments,
the second AI model is obtained based on local data; or
the second AI model is obtained based on K pieces of information, each of the K pieces of information indicates model information of an AI model of the another node and auxiliary information of the AI model of the another node, and K is a positive integer; or
the second AI model is obtained based on the local data and the K pieces of information.

In some embodiments, the node type includes any one of the following: a node type of performing local training based on the local data, a node type of performing merging processing based on an AI model of another node, and a node type of performing local training based on the local data and performing merging processing based on the AI model of the another node.

In some embodiments, the first information further indicates auxiliary information of the first AI model. The auxiliary information of the first AI model includes at least one of the following: type information of the first AI model, identification information of the first node, identification information of a receiving node of the first AI model, version information of the first AI model, time information for generating the first AI model, geographical location information for generating the first AI model, and distribution information of the local data of the first node.

In some embodiments, the model information of the first AI model and the auxiliary information of the first AI model are separately carried on different transmission resources, and the transmission resources include a time domain resource and/or a frequency domain resource.

In some embodiments, the first AI model is a model that can be understood by M nodes in a system in which the first node is located, and M is an integer greater than or equal to 2.

In some embodiments, the processing unit is further configured to determine the node type of the first node based on capability information and/or requirement information; or the transceiver unit is further configured to receive the indication information indicating the node type of the first node.

In some embodiments, the composition modules of the communication apparatus may further be configured to: perform the steps performed in the possible implementations of the fifth aspect, and achieve corresponding technical effects. For details, refer to the fifth aspect.

A twelfth aspect of this disclosure provides an AI model processing apparatus. The apparatus is a second node, or the apparatus is some components (for example, a processor, a chip, or a chip system) in a second node, or the apparatus may be a logical module or software that can implement all or some functions of a second node. In the twelfth aspect and a possible implementation of the twelfth aspect, an example in which the communication apparatus is the second node is used for description. The second node may be a terminal device or a network device.

The apparatus includes a transceiver unit.

The transceiver unit is used by the second node to receive indication information indicating a node type of a first node; and/or
the transceiver unit is configured to receive first information, where the first information indicates model information of a first AI model, and the first AI model is obtained based on the node type of the first node.

Optionally, the first AI model is obtained based on a second AI model and the node type of the first node.

In some embodiments,
the second AI model is obtained based on local data; or
the second AI model is obtained based on K pieces of information, each of the K pieces of information indicates model information of an AI model of the another node and auxiliary information of the AI model of the another node, and K is a positive integer; or
the second AI model is obtained based on the local data and the K pieces of information.

In some embodiments, the node type includes any one of the following: a node type of performing local training based on the local data, a node type of performing merging processing based on an AI model of another node, and a node type of performing local training based on the local data and performing merging processing based on the AI model of the another node.

In some embodiments, the first information further indicates auxiliary information of the first AI model. The auxiliary information of the first AI model includes at least one of the following: type information of the first AI model, identification information of the first node, identification information of a receiving node of the first AI model, version information of the first AI model, time information for generating the first AI model, geographical location information for generating the first AI model, and distribution information of the local data of the first node.

In some embodiments, the model information of the first AI model and the auxiliary information of the first AI model are separately carried on different transmission resources, and the transmission resources include a time domain resource and/or a frequency domain resource.

In some embodiments, the first AI model is a model that can be understood by M nodes in a system in which the first node is located, and M is an integer greater than or equal to 2.

In some embodiments, the apparatus further includes a processing unit. The processing unit is configured to determine a node type of the second node based on capability information and/or requirement information; or the transceiver unit is further configured to receive indication information indicating the node type of the second node.

In some embodiments, the composition modules of the communication apparatus may further be configured to: perform the steps performed in the possible implementations of the sixth aspect, and achieve corresponding technical effects. For details, refer to the sixth aspect.

A thirteenth aspect of embodiments of this disclosure provides a communication apparatus, including at least one processor. The at least one processor is coupled to a memory.

The memory is configured to store a program or instructions.

The at least one processor is configured to execute the program or instruction, so that the apparatus implements the method according to any one of the first aspect or the possible implementations of the first aspect, or the apparatus implements the method according to any one of the second aspect or the possible implementations of the second aspect, or the apparatus implements the method according to any one of the third aspect or the possible implementations of the third aspect, or the apparatus implements the method according to any one of the fourth aspect or the possible implementations of the fourth aspect, or the apparatus implements the method according to any one of the fifth aspect or the possible implementations of the fifth aspect, or the apparatus implements the method according to any one of the sixth aspect or the possible implementations of the sixth aspect.

A fourteenth aspect of embodiments of this disclosure provides a communication apparatus, including at least one logic circuit and an input/output interface.

The logic circuit is configured to perform the method according to any one of the first aspect or the possible implementations of the first aspect, or the logic circuit is configured to perform the method according to any one of the second aspect or the possible implementations of the second aspect, or the logic circuit is configured to perform the method according to any one of the third aspect or the possible implementations of the third aspect, or the logic circuit is configured to perform the method according to any one of the fourth aspect or the possible implementations of the fourth aspect, or the logic circuit is configured to perform the method according to any one of the fifth aspect or the possible implementations of the fifth aspect, or the logic circuit is configured to perform the method according to any one of the sixth aspect or the possible implementations of the sixth aspect.

A fifteenth aspect of embodiments of this disclosure provides a computer-readable storage medium storing one or more computer-executable instructions. When the computer-executable instructions are executed by a processor, the processor performs the method according to any one of the first aspect or the possible implementations of the first aspect, or the processor performs the method according to any one of the second aspect or the possible implementations of the second aspect, or the processor performs the method according to any one of the third aspect or the possible implementations of the third aspect, or the processor performs the method according to any one of the fourth aspect or the possible implementations of the fourth aspect, or the processor performs the method according to any one of the fifth aspect or the possible implementations of the fifth aspect, or the processor performs the method according to any one of the sixth aspect or the possible implementations of the sixth aspect.

A sixteenth aspect of embodiments of this disclosure provides a computer program product (or referred to as a computer program) storing one or more computer instructions. When the computer program product is executed by a processor, the processor performs the method according to any one of the first aspect or the possible implementations of the first aspect, or the processor performs the method according to any one of the second aspect or the possible implementations of the second aspect, or the processor performs the method according to any one of the third aspect or the possible implementations of the third aspect, or the processor performs the method according to any one of the fourth aspect or the possible implementations of the fourth aspect, or the processor performs the method according to any one of the fifth aspect or the possible implementations of the fifth aspect, or the processor performs the method according to any one of the sixth aspect or the possible implementations of the sixth aspect.

A seventeenth aspect of embodiments of this disclosure provides a chip system. The chip system includes at least one processor, configured to support a communication apparatus in implementing the function in any one of the first aspect or the possible implementations of the first aspect; or configured to support a communication apparatus in implementing the function in any one of the second aspect or the possible implementations of the second aspect; or configured to support a communication apparatus in implementing the function in any one of the third aspect or the possible implementations of the third aspect; or configured to support a communication apparatus in implementing the function in any one of the fourth aspect or the possible implementations of the fourth aspect; or configured to support a communication apparatus in implementing the function in any one of the fifth aspect or the possible implementations of the fifth aspect; or configured to support a communication apparatus in implementing the function in any one of the sixth aspect or the possible implementations of the sixth aspect.

In some embodiments, the chip system may further include a memory. The memory is configured to store program instructions and data that are necessary for the communication apparatus. The chip system may include a chip, or may include a chip and another discrete component. Optionally, the chip system further includes an interface circuit, and the interface circuit provides program instructions and/or data for the at least one processor.

An eighteenth aspect of embodiments of this disclosure provides a communication system. The communication system includes the communication apparatus according to the third aspect and the communication apparatus according to the fourth aspect, and/or the communication system includes the communication apparatus according to the fifth aspect and the communication apparatus according to the sixth aspect, and/or the communication system includes the communication apparatus according to the seventh aspect and the communication apparatus according to the eighth aspect, and/or the communication system includes the communication apparatus according to the ninth aspect and the communication apparatus according to the tenth aspect, and/or the communication system includes the communication apparatus according to the eleventh aspect and the communication apparatus according to the twelfth aspect, and/or the communication system includes the communication apparatus according to the thirteenth aspect, and/or the communication system includes the communication apparatus according to the fourteenth aspect.

For technical effects brought by any implementation manner in the seventh aspect to the eighteenth aspect, refer to technical effects brought by different implementation manners in the first aspect to the sixth aspect.

In some embodiments, after the first node determines the first AI model, the first node sends the first information indicating the model information of the first AI model and the auxiliary information of the first AI model. Compared with a manner in which different nodes exchange only respective AI models, in addition to the model information of the first AI model, the first information may further indicate the auxiliary information of the first AI model, so that a receiver of the first information can perform AI model processing (for example, training and merging) on the model information of the first AI model based on the auxiliary information of the first AI model, thereby improving performance of an AI model obtained by the receiver of the first information by performing processing based on the first AI model.

In some other embodiments, the first node obtains the local AI model used to complete the AI task of the first node, the first node determines the public AI model based on the local AI model, and the first node sends the first information indicating the model information of the public AI model. The public AI model is a model that can be understood by the M nodes in the system in which the first node is located. In other words, the public AI model indicated by the first information sent by the first node is a model that can be understood by the M nodes in the system in which the first node is located, so that when the M nodes are of a plurality of different node types, another node can understand the first AI model and further perform model processing after receiving the first information.

In some other embodiments, the first node may determine the node type of the first node. Subsequently, the first node may perform AI model processing based on the node type. In this way, the first node can perform different AI model processing processes based on different node types to resolve a problem of a single node function, thereby improving flexibility.

### BRIEF DESCRIPTION OF DRAWINGS

FIG. 1a is a diagram of a communication system according to an example embodiment of this disclosure;

FIG. 1b is another diagram of a communication system according to an example embodiment of this disclosure;

FIG. 1c is another diagram of a communication system according to an example embodiment of this disclosure;

FIG. 2a is a diagram of an AI processing process according to an example embodiment of this disclosure;

FIG. 2b is another diagram of an AI processing process according to an example embodiment of this disclosure;

FIG. 2c is another diagram of an AI processing process according to an example embodiment of this disclosure;

FIG. 2d is another diagram of an AI processing process according to an example embodiment of this disclosure;

FIG. 2e is another diagram of an AI processing process according to an example embodiment of this disclosure;

FIG. 3a is a diagram of an example AI processing process implemented based on federated learning;

FIG. 3b is a diagram of an example AI processing process implemented based on distributed learning;

FIG. 4 is a diagram of interactions in an AI model processing method according to an example embodiment of this disclosure;

FIG. 5a is a diagram of an AI model processing method according to an example embodiment of this disclosure;

FIG. 5b is another diagram of an AI model processing method according to an example embodiment of this disclosure;

FIG. 5c is another diagram of an AI model processing method according to an example embodiment of this disclosure;

FIG. 5d is another diagram of an AI model processing method according to an example embodiment of this disclosure;

FIG. 6 is another diagram of interactions in an AI model processing method according to an example embodiment of this disclosure;

FIG. 7 is another diagram of interactions in an AI model processing method according to an example embodiment of this disclosure;

FIG. 8 is a diagram of a communication apparatus according to an example embodiment of this disclosure;

FIG. 9 is another diagram of a communication apparatus according to an example embodiment of this disclosure;

FIG. 10 is another diagram of a communication apparatus according to an example embodiment of this disclosure; and

FIG. 11 is another diagram of a communication apparatus according to an example embodiment of this disclosure.

### DESCRIPTION OF EMBODIMENTS

The following describes technical solutions with reference to the accompanying drawings in embodiments of this disclosure. All other embodiments obtained by a person of ordinary skill in the art based on embodiments of this disclosure without creative efforts shall fall within the protection scope of this disclosure.

First, some terms in embodiments of this disclosure are explained and described to facilitate understanding by a person skilled in the art.
(1) Terminal device: The terminal device may be a wireless terminal device that can receive scheduling and indication information of a network device. A wireless terminal device may be a device providing voice and/or data connectivity for a user, a handheld device having a wireless connection function, or another processing device connected to a wireless modem.

The terminal device may communicate with one or more core networks or an internet through a radio access network (RAN). The terminal device may be a mobile terminal device such as a mobile phone (or referred to as a “cellular” phone), a computer, or a data card. For example, the terminal device may be a portable, pocket-sized, handheld, computer built-in, or vehicle-mounted mobile apparatus that exchanges voice and/or data with the radio access network. For example, the wireless terminal device may be a device such as a personal communication service (PCS) phone, a cordless phone, a session initiation protocol (SIP) phone, a wireless local loop (WLL) station, a personal digital assistant (PDA), a tablet computer (e.g. a Pad), or a computer having a wireless transceiver function. The wireless terminal device may also be referred to as a system, a subscriber unit, a subscriber station, a mobile station (MS), a remote station, an access point (AP), a remote terminal device (also referred to as a remote terminal), an access terminal device (also referred to as a access terminal), a user terminal device (also referred to as a user terminal), a user agent, a subscriber station device (SS), customer premises equipment (CPE), a terminal, user equipment (UE), a mobile terminal (MT), or the like.

By way of example, and not limitation, in embodiments of this disclosure, the terminal device may alternatively be a wearable device. The wearable device may also be referred to as a wearable intelligent device, an intelligent wearable device, or the like, and is a general term of wearable devices that are intelligently designed and developed for daily wear by using a wearable technology, for example, glasses, gloves, watches, clothes, and shoes. The wearable device is a portable device that is directly worn on the body or integrated into clothes or an accessory of a user. The wearable device is not only a hardware device, but also a device with a strong function implemented with the support of software, data exchange, and cloud interaction. In a broad sense, wearable intelligent devices include full-featured and large-sized devices that can implement all or a part of functions without depending on smartphones, for example, smart watches or smart glasses, and include devices that focus on only one type of disclosure function and need to collaboratively work with other devices such as smartphones, for example, various smart bands, smart helmets, or smart jewelry for monitoring physical signs.

Alternatively, the terminal may be a drone, a robot, a terminal in device-to-device communication (D2D), a terminal in vehicle to everything (V2X), a virtual reality (VR) terminal device, an augmented reality (AR) terminal device, a wireless terminal in industrial control, a wireless terminal in self driving, a wireless terminal in telemedicine, a wireless terminal in a smart grid, a wireless terminal in transportation safety, a wireless terminal in a smart city, or a wireless terminal in a smart home.

In addition, the terminal device may be a terminal device in an evolved communication system (for example, a sixth generation (6G) communication system) after a fifth generation (5G) communication system, a terminal device in a future evolved public land mobile network (PLMN), or the like. For example, a 6G network may further extend a form and a function of a 5G communication terminal, and a 6G terminal includes but is not limited to a vehicle, a cellular network terminal (integrating a function of a satellite terminal), a drone, and an internet of things (IoT) device.

In embodiments of this disclosure, the terminal device may further obtain an AI service provided by a network device. Optionally, the terminal device may further have an AI processing capability.
(2) Network device: The network device may be a device in a wireless network. For example, the network device may be a RAN node (or a device) connecting a terminal device to the wireless network, and may also be referred to as a base station. Currently, some examples of RAN devices are: a base station gNB (gNodeB) in a 5G communication system, a transmission reception point (TRP), an evolved NodeB (eNB), a radio network controller (RNC), a NodeB (NB), a home base station (for example, a home evolved NodeB or a home NodeB, (HNB)), a base band unit (BBU), or a wireless fidelity (Wi-Fi) access point (AP). In addition, in a network structure, the network device may include a central unit (CU) node, a distributed unit (DU) node, or a RAN device including a CU node and a DU node.

The network device may be another apparatus providing a wireless communication function for a terminal device. A specific technology and a specific device form that are used for the network device are not limited in embodiments of this disclosure.

The network device may further include a core network device. For example, the core network device includes network elements such as a mobility management entity (MME), a home subscriber server (HSS), a serving gateway (S-GW), a policy and charging rules function (PCRF), and a public data network gateway (PDN gateway or P-GW) in a fourth generation (4G) network, and an access and mobility management function (AMF), and a user plane function (UPF) or a session management function (SMF) in a 5G network. In addition, the core network device may further include another core network device in a 5G network and a next generation network of the 5G network.

In embodiments of this disclosure, the network device may further be a network node having an AI capability, and may provide an AI service for a terminal or another network device, for example, may be an AI node, a computing node, a RAN node having an AI capability, or a core network element having an AI capability on a network side (an access network or a core network).

In embodiments of this disclosure, an apparatus configured to implement a function of a network device may be a network device, or may be an apparatus, for example, a chip system, that can support the network device in implementing the function. The apparatus may be installed in the network device. In the technical solutions provided in embodiments of this disclosure, the technical solutions provided in embodiments of this disclosure are described by using an example in which the apparatus configured to implement the function of the network device is the network device.
(3) Configuration and preconfiguration: In this disclosure, both the configuration and the preconfiguration are used. The configuration means that a network device/server sends configuration information of some parameters or parameter values to a terminal by using a message or signaling, so that the terminal determines a communication parameter or a transmission resource based on the values or the information. Similar to the configuration, the preconfiguration may be parameter information or a parameter value negotiated by a network device/server with a terminal device in advance, or may be parameter information or a parameter value that is used by a base station/network device or a terminal device and that is specified in a standard protocol, or may be parameter information or a parameter value pre-stored in a base station/server or a terminal device.

Further, these values and parameters may be changed or updated.
(4) Terms “system” and “network” in embodiments of this disclosure may be used interchangeably. “A plurality of” refers to two or more than two. The term “and/or” describes an association relationship of associated objects, and indicates that at least three relationships may exist. For example, A and/or B may indicate the following three cases: Only A exists, both A and B exist, and only B exists, where A and B may be singular or plural. The character “/” generally indicates an “or” relationship between the associated objects. “At least one of the following items (pieces)” or a similar expression thereof refers to any combination of these items, including any combination of singular items (pieces) or plural items (pieces). For example, “at least one of A, B, and C” includes A, B, C, AB, AC, BC, or ABC. In addition, unless otherwise specified, ordinal numbers such as “first” and “second” in embodiments of this disclosure are used to distinguish between a plurality of objects, and are not used to limit a sequence, a time sequence, priorities, or importance of the plurality of objects.

In this disclosure, unless otherwise specified, for same or similar parts in embodiments, refer to each other. In embodiments of this disclosure and methods/designs/implementations in embodiments, unless otherwise specified or logical conflicts occur, terms and/or descriptions between different embodiments and between the methods/designs/implementations in embodiments are consistent and may be mutually referenced, different embodiments and technical features in the methods/designs/implementations in embodiments may be combined to form a new embodiment, method, or implementation based on an internal logical relationship thereof. The following implementations of this disclosure are not intended to limit the protection scope of this disclosure.

This disclosure may be applied to a long term evolution (LTE) system, a new radio (NR) system, or a communication system evolved after 5G (for example, 6G). The communication system includes at least one network device and/or at least one terminal device.

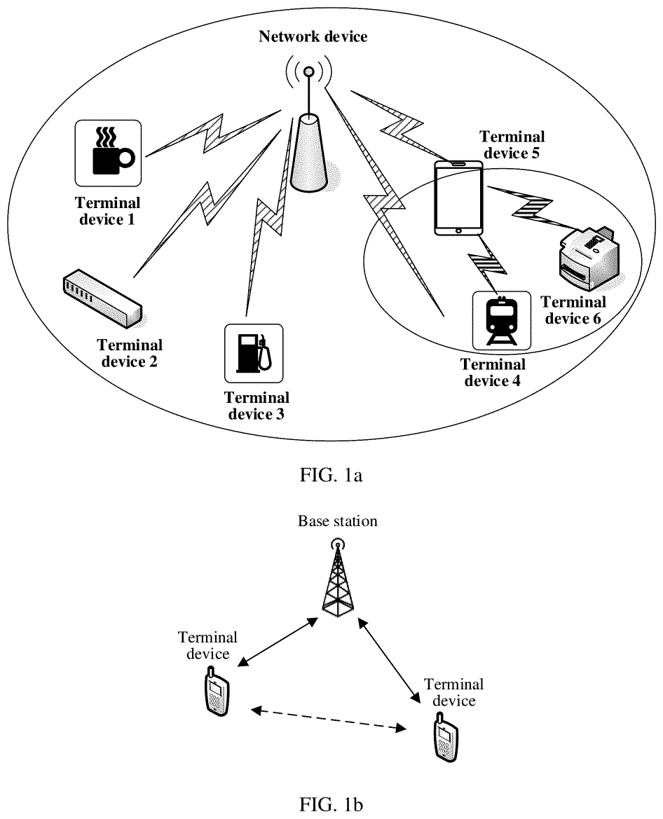

FIG. 1a is a diagram of a communication system according to this disclosure. FIG. 1a shows an example of one network device 101 and six terminal devices. The six terminal devices are a terminal device 1, a terminal device 2, a terminal device 3, a terminal device 4, a terminal device 5, and a terminal device 6. In the example shown in FIG. 1a, an example in which the terminal device 1 is a smart teacup, the terminal device 2 is a smart air conditioner, the terminal device 3 is a smart fuel dispenser, the terminal device 4 is a vehicle, the terminal device 5 is a mobile phone, and the terminal device 6 is a printer is used for description.

As shown in FIG. 1a, an AI configuration information sending entity may be the network device. AI configuration information receiving entities may be the terminal device 1 to the terminal device 6. In this case, the network device and the terminal device 1 to the terminal device 6 form a communication system. In the communication system, the terminal device 1 to the terminal device 6 may send data to the network device, and the network device needs to receive the data sent by the terminal device 1 to the terminal device 6. In addition, the network device may send configuration information to the terminal device 1 to the terminal device 6.

Optionally, the AI configuration information may include indication information of a node type mentioned below. The data may include model information of an AI model and/or auxiliary information of the AI model mentioned below.

For example, in FIG. 1a, the terminal device 4 to the terminal device 6 may also form a communication system. The terminal device 5 serves as a network device, that is, an AI configuration information sending entity. The terminal device 4 and the terminal device 6 serve as terminal devices, that is, AI configuration information receiving entities. For example, in an internet of vehicles system, the terminal device 5 separately sends AI configuration information to the terminal device 4 and the terminal device 6, and receives data sent by the terminal device 4 and the terminal device 6; and correspondingly, the terminal device 4 and the terminal device 6 receive the AI configuration information sent by the terminal device 5, and send the data to the terminal device 5.

The communication system shown in FIG. 1a is used as an example. In addition to a communication-related service, an AI-related service may be performed between different devices (including between network devices, between a network device and a terminal device, and/or between terminal devices). For example, as shown in FIG. 1b, an example in which a network device is a base station is used. A communication-related service and an AI-related service may be performed between the base station and one or more terminal devices, and the communication-related service and the AI-related service may also be performed between different terminal devices. For another example, as shown in FIG. 1c, an example in which terminal devices include a television and a mobile phone is used. A communication-related service and an AI-related service may also be performed between the television and the mobile phone.

With the advent of the big data era, each device (including a network device and a terminal device) generates a large amount of raw data in various forms. The data will be generated in a form of “island” and exist in every corner of the world. Traditional centralized learning requires each distributed device to transmit local data to a server at a central end, and then the collected data is used for model training and learning. However, this architecture is gradually restricted by the following factors with the development of times:
(1) Distributed devices are widely distributed in various regions and corners of the world. These devices will continuously generate and accumulate massive amounts of raw data at a fast speed. If the central end needs to collect raw data from all distributed devices, huge communication losses and computing power requirements are inevitably caused.
(2) As actual scenarios in real life become more complex, more learning tasks require that the distributed device can make a timely and effective decision and feedback. In conventional centralized learning, because a large amount of data is uploaded, a large latency is inevitably caused. Consequently, centralized learning cannot meet a real-time requirement of an actual task scenario.
(3) In consideration of problems such as industry competition, user privacy security, and complex administrative procedures, centralized integration of data faces increasing resistance and constraints. Therefore, for system deployment, data increasingly tends to be locally stored, and the distributed device completes local computation of a model.

Therefore, how to design a machine learning framework while meeting data privacy, security, and regulatory requirements so that AI systems can use their own data more efficiently and accurately becomes an important issue in the current artificial intelligence development. Machine learning is an important research direction in the field of artificial intelligence, and the research on neural networks is a hot topic in recent years. The following briefly describes neural networks that may be used in the present technology.

### 1. Fully-Connected Neural Network

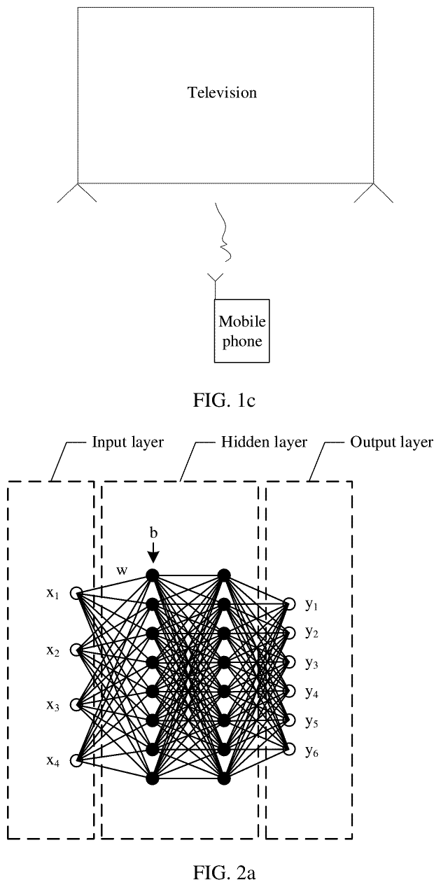

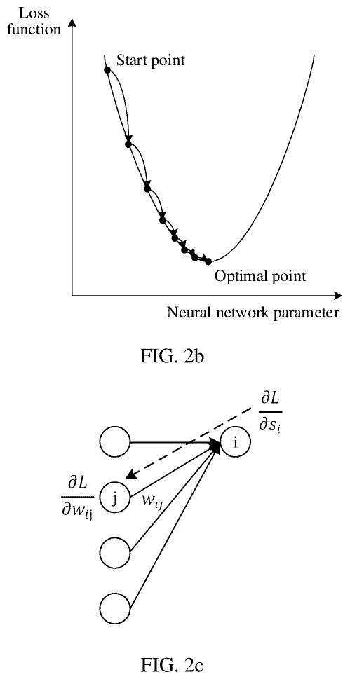

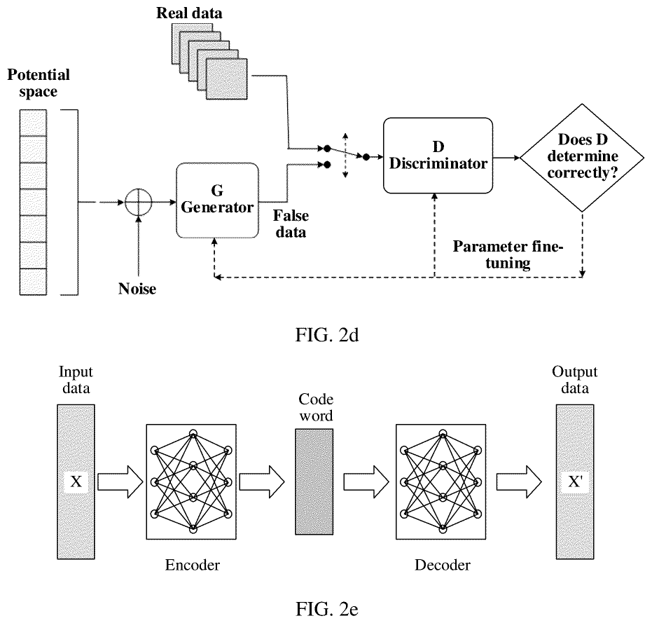

The fully-connected neural network is also referred to as a multilayer perceptron (MLP). As shown in FIG. 2a, one MLP includes one input layer (also referred to as left side), one output layer (also referred to as right side), and a plurality of hidden layers (middle). Each layer of the MLP includes several nodes, which are referred to as neurons. Neurons at two neighboring layers are connected to each other in pairs.

Optionally, in consideration of neurons at two neighboring layers, an output h of a neuron at a lower layer is a weighted sum of all neurons x at an upper layer connected to the neuron at the lower layer, and may be expressed as follows by using an activation function:

$$h = f ( wx + b )$$

where w is a weight matrix, b is a bias vector, and f is the activation function.

Further, optionally, the output of the neural network may be recursively expressed as:

$$y = {f}_{n} ( {w}_{n} {f}_{n - 1} ( … ) + {b}_{n} )$$

where n is an index of the neural network layer, 1≤n≤N, and N is a total quantity of layers of the neural network.

In other words, the neural network may be understood as a mapping relationship from an input data set to an output data set. The neural network is usually initialized randomly, and a process of obtaining the mapping relationship from random w and b by using existing data is referred to as training of the neural network.

Optionally, a specific training manner is to evaluate an output result of the neural network by using a loss function. As shown in FIG. 2b, an error may be backpropagated, and neural network parameters (including w and b) can be iteratively optimized by using a gradient descent method until the loss function reaches a minimum value, that is, the “optimal point” in FIG. 2b. It can be understood that a neural network parameter corresponding to the “optimal point” in FIG. 2b may be used as a neural network parameter in trained AI model information.

Further, optionally, a gradient descent process may be expressed as:

$$θ ← θ - η \frac{\partial L}{\partial θ}$$

where θ is a to-be-optimized parameter (including w and b), L is the loss function, η is a learning rate controlling a step of gradient descent, ∂ indicates a derivation operation, and ∂L/∂θ indicates a derivative of calculating θ for L.

Further, optionally, a backpropagation process uses a chain method for obtaining a bias. As shown in FIG. 2c, a gradient of a parameter at a previous layer may be obtained by recursive calculation of a gradient of a parameter at a next layer, and may be expressed as follows:

$$\frac{\partial L}{\partial {w}_{ij}} = \frac{\partial L}{\partial {s}_{i}} \frac{\partial {s}_{i}}{\partial {w}_{ij}}$$

where wᵢⱼ is a weight of a connection between a node j and node i, and sᵢ is an input weighted sum on the node i.

### 2. Generative Adversarial Network (GAN)

A generative model (GM) is a rapidly developing research direction in the field of computer vision in recent years. In 2014, Ian Goodfellow proposed a generative model generating simulation data based on probability distribution, named a generative adversarial network (GAN). Because of its ability to approximate complex probability density functions, the generative adversarial network has been proved to be available for various machine learning tasks, including image generation, video generation, and natural language processing.

As shown in FIG. 2d, a generative adversarial network usually includes at least one generator and at least one discriminator. The generator randomly selects a sample from a potential space as an input, outputs a false sample after processing, and requires the output false sample to simulate real sample data in a training set as real as possible. The input of the discriminator is a real sample or a false sample of the generator, and a probability value that an input sample is a real sample is output. The discriminator aims to identify the false sample generated by the generator from the real sample, and the generator needs to deceive the discriminator as hard as possible, so that the discriminator cannot determine the authenticity of the input sample. The generator and the discriminator constantly fight against each other and adjust their model parameters, so that the discriminator cannot determine whether an output sample of the generator is a real sample.

### 3. Autoencoder

The autoencoder is of an artificial neural network structure, and a diagram of the autoencoder is shown in FIG. 2e. The autoencoder is generally used to indicate (or encode) a group of data, is usually used for dimension reduction, and includes an encoder and a decoder. The encoder encodes input data by using one or more layers of neural networks to obtain a dimension-reduced code word. The decoder reconstructs the code word into output data by using a single-layer or multi-layer neural network. The output data needs to be the same as the input data of the encoder as same as possible. The encoder and the decoder are trained together to meet the above requirements.

In recent years, AI technologies have made significant progress in fields such as machine vision and natural language processing, and gradually become popular in real life. It is foreseeable that AI will be ubiquitous in various connected devices (such as terminals and edges). In some possible implementations, a communication system may become a platform for large-scale machine learning and AI services. A terminal device may enjoy an AI inference service or an AI model training service from a network, and may participate in data collection required for network model training, or even participate in distributed model training.

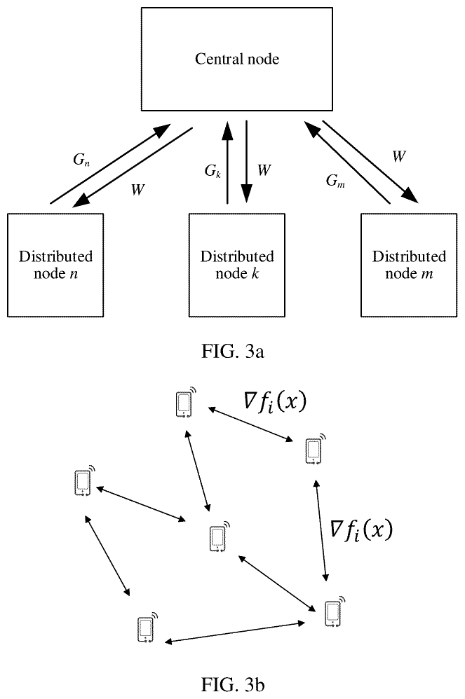

In some embodiments, federated learning (FL) is widely used as a typical AI data processing mode. A concept of FL is proposed to effectively resolve difficulties faced by the current development of artificial intelligence. While ensuring user data privacy and security, the federated learning facilitates various edge devices and a server at a central end to collaborate to efficiently complete a learning task of a model. As shown in FIG. 3a, an FL architecture is the most widely used training architecture in the FL field currently. The FedAvg algorithm is a basic algorithm of FL. An example in which a central node is a central end and a distributed node is a client is used. An algorithm process thereof is approximately as follows:
(1) The central end initializes a to-be-trained model w⁰_{g} and broadcasts the model to all client devices.
(2) In a (t∈[1, T])th round, a client k∈[1, K] performs E times of epoch training on a received global model w_{g}^{t-1} based on a local dataset [symbol] ₖ to obtain a local training result wₖ^{t}, and reports the local training result to a central node.
(3) The central node summarizes and collects local training results from all (or some) clients. It is assumed that a set of clients that upload a local model in a t th round is [symbol] ^{t}, and the central end performs weighted calculation by using a quantity of samples of a corresponding client as a weight to obtain a new global model. A specific update rule is

$${w}_{g}^{t} = {\sum }_{k ∈ {𝒮}^{t}} \frac{{D}_{k} {w}_{k}^{t}}{{\sum }_{k ∈ {𝒮}^{t}} {D}_{k}} .$$

Then, the central end broadcasts the global model w_{g}^{t} of the latest version to all client devices to perform a new round of training.
(4) Steps (2) and (3) are repeated, until the model converges finally or a quantity of training rounds reaches an upper limit.

Optionally, convergence generally means that performance of a model obtained through training meets a preset requirement. For example, a model used for an image classification task is trained through FL, and preset classification accuracy is 95%. As training is performed, accuracy performance of the model is evaluated by using a test set. When it is found that the accuracy reaches 95% or above, it may be determined that the model is converged, and training is stopped. In addition, due to poor design of factors such as a model structure design, a parameter selection, and a training method, a performance requirement may never be preset. In this case, an upper limit needs to be set for the quantity of training rounds. Even if the quantity of training rounds reaches the upper limit, training needs to be stopped if the model does not reach the preset performance.

In addition to the local AI model wₖ^{t}, the trained local gradient gₖ^{t} may also be reported. The central node averages the local gradient, and updates the global model based on a direction of the average gradient.

As can be learned, in an FL framework, a dataset exists on a distributed node. To be specific, the distributed node collects a local dataset, performs local training, and reports a local result (model or gradient) obtained through training to the central node. The central node does not have a dataset, is only responsible for merging training results of the distributed nodes to obtain a global model, and delivers the global model to the distributed nodes.

As can be learned from the foregoing descriptions, in a federated learning method, there is a need for a central node in a system to perform model merging. Therefore, the system is of a star structure, and has a problem of poor robustness. Once a problem occurs on the central node (for example, the central node is attacked), the entire system is paralyzed. In addition, in a federated learning system, a prerequisite for merging a plurality of local AI models in a weighted average manner is that the local AI models have a same structure and a same quantity of parameters. However, in an actual network, device capabilities of various distributed nodes are different, and the distributed nodes are required to use a same local AI model. This usually limits flexibility of the distributed nodes and cannot meet different requirements of different distributed nodes.

In some embodiments, a decentralized AI data processing mode is used as an improvement to the federated learning AI data processing mode. In this mode, no central node needs to be set, and system robustness can be improved. In a decentralized system, after calculating a local AI model by using local data and a local target, each node exchanges an AI model with a neighboring node that is reachable in communication, and further processes (for example, trains and merges) a local AI model based on the exchanged AI model.

For example, different from federated learning, a decentralized learning process in a decentralized AI data processing mode is shown in FIG. 3b, that is, a complete distributed system without a central node. A design objective f(x) of the system is generally an average value of targets fᵢ(x) of all nodes, that is,

$$f ( x ) = \frac{1}{n} {\sum }_{i = 1}^{n} {f}_{i} ( x ) ,$$

where n is a quantity of distributed nodes, and x is a to-be-optimized parameter. In machine learning, x is a parameter of a machine learning (for example, a neural network) model. Each node calculates a local gradient ∇fᵢ(x) by using local data and the local target fᵢ(x), and then sends the local gradient to a neighboring node that is reachable in communication. After receiving gradient information sent by a neighboring node of any node, the node may update a parameter x of a local AI model based on the following formula:

$${x}_{i}^{k + 1} = {x}_{i}^{k} - {α}_{k} ( \frac{1}{\vert {N}_{i} \vert} {\sum }_{j ∈ {N}_{i}} ∇ {f}_{j} ( {x}_{j}^{k} ) )$$

Nᵢ is a neighboring node set of a node i, |Nᵢ| indicates a quantity of elements in the neighboring node set of the node i, that is, a quantity of neighboring nodes of the node i, a superscript kindicates a k^{th} (where k is a positive integer) round of training, and αₖ is a training step used in the k^{th} round of training. Through information exchange between nodes, the decentralized learning system will finally learn a unified model.

However, in the foregoing decentralized system, because there is no unified scheduling of the central node, how to implement AI model processing after different distributed nodes receive an AI model from another node is an urgent technical problem to be resolved. For example, there is a version difference between AI models used by different distributed nodes in a training process. For example, some nodes process a local AI model based on a received relatively new AI model (or with a relatively large quantity of iterations), and some other nodes process a local AI model based on a received relatively old AI parameter (or with a relatively small quantity of iterations). Consequently, AI model versions obtained by different nodes in the distributed system are inconsistent, and AI model performance obtained by the system is affected.

To resolve the foregoing problem, this disclosure provides an AI model processing method and a related device. The following further provides descriptions with reference to the accompanying drawings.

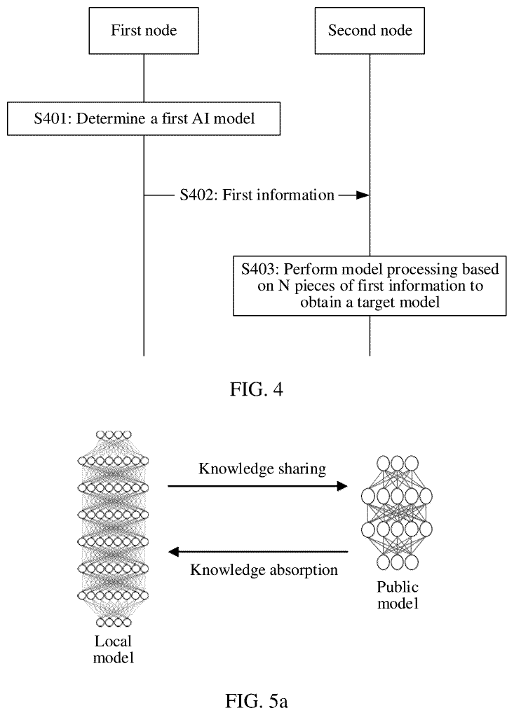

FIG. 4 is a diagram of interactions in an AI model processing method according to this disclosure. The method includes the following steps.
S401: A first node determines a first AI model.
S402: The first node sends first information, where the first information indicates model information of the first AI model and auxiliary information of the first AI model.

In this embodiment, the first node sends the first information in step S402. Correspondingly, for a second node, the second node receives, in step S402, N pieces of first information sent by N first nodes, where Nis a positive integer. The first information indicates the model information of the first AI model and the auxiliary information of the first AI model.

In some embodiments, the model information of the first AI model is used to construct the first AI model. For example, the model information may include at least one of parameter information of a model, structure information of the model, and the like.

Optionally, the structure information of the model may include at least one of a quantity of model layers, a quantity of neurons at each layer in the model, a connection relationship between layers in the model, and the like.

In some embodiments, the first AI model determined by the first node in step S401 is a model that can be understood by M nodes in a system in which the first node is located, and M is an integer greater than or equal to 2. Correspondingly, the first AI model indicated by the first information sent by the first node in step S402 is a model that can be understood by the M nodes in the system in which the first node is located, so that when the M nodes are of a plurality of different node types, another node can understand the first AI model and further perform model processing after receiving the first information.

Optionally, the first AI model determined by the first node in step S401 may alternatively not be a model that can be understood by some or all of the M nodes in the system in which the first node is located. Correspondingly, after receiving the model information of the first AI model, some or all of the M nodes may send the model information of the first AI model to another node (for example, a server, a controller, a network device, or a central node), so that the another node performs model processing based on the model information of the first AI model to obtain and send model information of an comprehensible model to some or all of the M nodes, so that some or all of the M nodes perform a subsequent model processing process based on the model information of the comprehensible model.

Optionally, the first AI model determined by the first node in step S401 may alternatively not be a model that can be understood by some or all of the M nodes in the system in which the first node is located. Correspondingly, after receiving the model information of the first AI model, some or all of the M nodes may discard an incomprehensible model.

In some embodiments, the first AI model is a model that can be understood by the M nodes in the system in which the first node is located. This may be expressed as that the first AI model is a model common to the M nodes in the system in which the first node is located. A model structure of the first AI model is a model structure that can be understood by the M nodes in the system in which the first node is located, a model structure of the first AI model is a model structure common to the M nodes in the system in which the first node is located, the first AI model is a public model of the system in which the first node is located, or a model structure of the first AI model is a public model structure of the system in which the first node is located.

An example in which a model that can be understood by the M nodes in the system in which the first node is located is a public AI model is used. Correspondingly, an AI model locally processed by each of the M nodes in the system in which the first node is located may be a mode that cannot be understood by another node, and the model may be referred to as a local AI model. The following describes an example of a process of obtaining a public AI model and a local AI model for any one of the M nodes.

### 1. Process of Obtaining the Local AI Model

In the M nodes in the system in which the first node is located, a local AI model of each node is used for a learning task of the node. Local AI model structures and quantities of parameters of different nodes may be different.

In some embodiments, each of the M nodes in the system in which the first node is located may select a proper local AI model based on capability information (that is, a device capability of the device) and/or requirement information (that is, a local task requirement).

Specifically, the capability information (that is, the device capability of the device) mainly includes a computing capability and a storage capability. The computing capability is generally determined by a computing module in the device. The computing module may include at least one of a central processing unit (CPU), a graphics processing unit (GPU), a neural processing unit (NPU), a tensor processing unit (TPU), and the like. For example, floating-point operations per second (flops) are used as a unit, which describes a speed at which a device can perform model training and inference. The storage capability is generally determined by a storage module (such as a video memory/cache/memory) in the device, and is in a unit of byte (or a unit such as KB/MB/GB based on bytes), which describes a size of a model that can be stored in the device.

Optionally, the requirement information (that is, the requirement of the local task) generally refers to a performance requirement when a node completes a particular local task by using a model, for example, positioning precision in a positioning task, classification accuracy in a classification task, a mean square error in an information reconstruction task, or a compression ratio in a compression task.

As can be learned from the foregoing content, when configuring a local AI model, each of the M nodes in the system in which the first node is located may select a model that meets the local task requirement and that has a lowest computing capability and storage capability requirement as the local AI model. For example, when a plurality of models can meet the local task requirement, a model with a smallest quantity of model parameters and a smallest model training/inference calculation amount is selected; or a model with best performance may be selected, as the local AI model, from models whose computing and storage capabilities are less than or equal to those of the node.

Optionally, each of the M nodes in the system in which the first node is located may alternatively configure the local AI model in a preconfiguration manner. For example, a system or a standard may provide a group of optional model libraries for a specified task, so that each node selects the local AI model from the model libraries.

In addition, the local AI model may be configured by a management node in the system in which the first node is located, and then is delivered or installed to each node; or may be configured by each node. If the local AI model is configured by the management node in the system in which the first node is located, each node may further report a computing capability, a storage capability, and a task requirement of the node to the management node.

### 2. Process of Obtaining the Public AI Model

The public AI model is used to transfer knowledge between the M nodes in the system in which the first node is located. Different nodes in the system use public AI models with a same structure and a same quantity of parameters. Such an isomorphic public AI model design helps simplify a mechanism design of model transmission between nodes (for implementation of model transmission, refer to FIG. 3b and related descriptions).

Similarly, the public AI model may be configured or preconfigured by another node, for example, is specified in advance by a management node or a standard. Different public AI models may be used for different learning tasks (such as channel state information (CSI) compression, beam management, and positioning).

In addition, a computing capability and/or a storage capability of each node in the system in which the first node is located needs to be considered for configuration of the public AI model. For example, when the management node determines the public AI model, the management node may collect computing capability and storage capability information of each node, and determine the public AI model based on a computing capability and a storage capability of a node with a weakest capability. For another example, when a public AI model is specified in advance in a preconfiguration manner, the standard should specify both a computing capability requirement and a storage capability requirement that correspond to the public AI model. Before each node joins the system, it should be ensured that a corresponding capability of the node is not less than the capability requirement specified in the standard.

Optionally, in the foregoing implementation process, the local AI model and the public AI model are generally configured at the beginning of system construction. When a system status (for example, an environment in which the system is located and a capability and a requirement of each node) changes, the local AI model and the public AI model may be configured again or reset.

In some embodiments, the local AI model and the public AI model that are mentioned above may be oriented to a same function. For example, the local AI model and the public AI model may have a same function. For example, both the local AI model and the public AI model are used for tasks such as positioning, classification, reconstruction, and compression. In this case, only model structures, parameter quantities, and performance of the local AI model and the public AI model are different.

In some embodiments, the local AI model and the public AI model that are mentioned above may be oriented to different functions, in other words, functions of the local AI model and the public AI model may be different. For example, each node generates data based on a GAN structure. In this case, the local AI model may be a generator model in the GAN structure, and the public AI model may be a discriminator model in the GAN structure, that is, each node trains and updates a local generator model and discriminator model based on local data and a discriminator model sent by a neighboring node, and sends the updated discriminator model to the neighboring node. The discriminator model includes information related to local data of each node, and an interactive discriminator model realizes knowledge exchange between nodes. For another example, the local AI model and the public AI model are two parts of a completed model. For example, the local AI model is an encoder of an autoencoder model, and the public AI model is a decoder of the autoencoder model. Each node may train different encoders (e.g. local AI models) and a same decoder (e.g. a public AI model) by using local data, and then send the decoder (e.g. the public AI model) to a neighboring node. The decoder part carries local data information of each node, so that knowledge is exchanged between nodes.

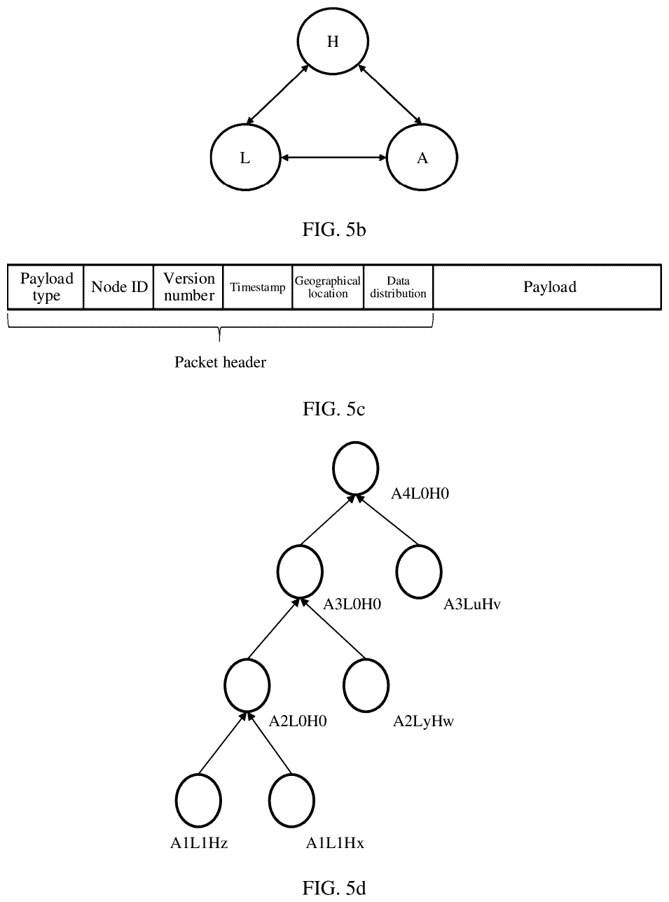

For example, as shown in FIG. 5a, there is an implementation process of “knowledge sharing” and/or “knowledge absorption” between the local AI model and the public AI model that are mentioned above.

For example, “knowledge sharing” refers to obtaining (or updating) the public AI model based on the local AI model. When the local AI model and the public AI model are oriented to a same function, knowledge sharing may be implemented by using existing technologies of knowledge distillation, pruning, and expansion. When the local AI model and the public AI model are oriented to different functions, knowledge sharing is implemented through joint training of the local AI model and the public AI model.

For another example, “knowledge absorption” refers to updating the local AI model based on the public AI model. Similarly, when the local AI model and the public AI model are oriented to a same function, knowledge absorption may be implemented by using the existing technologies of knowledge distillation, pruning, and expansion. When the local AI model and the public AI model are oriented to different functions, knowledge absorption is implemented through joint training of the local AI model and the public AI model.

In some embodiments, the first AI model determined by the first node in step S401 is obtained based on a node type of the first node. Specifically, in the decentralized system shown in FIG. 3b, all nodes use a same learning model (e.g. all parameters are x), and possible different capabilities and requirements of the nodes are not considered. In addition, the foregoing averaging manner is used for model merging, and functions of the nodes are the same. Function differentiation of the nodes is not considered in the foregoing system. In this embodiment, the first

AI model indicated by the first information sent by the first node may be a model obtained by the first node based on the node type of the first node. When the first AI model is obtained based on at least the node type of the first node, the first node can perform different AI model processing processes based on different node types to resolve a problem of a single node function, thereby improving flexibility.

Optionally, the first AI model determined by the first node in step S401 is obtained based on the node type of the first node and a second AI model. When the first AI model is obtained based on at least the second AI model, the first AI model indicated by the first information sent by the first node may be a model that can be understood by another node, so that the another node performs further model processing after receiving the first AI model.

Optionally, the node type includes any one of the following: a node type of performing local training based on local data (denoted as a node L for ease of description below), a node type of performing merging processing based on an AI model of another node (denoted as a node A for ease of description below), and a node type of performing local training based on the local data and performing merging processing based on the AI model of the another node (denoted as a node H for ease of description below). Specifically, a node type used to obtain the first AI model may be any one of the foregoing implementations to improve solution implementation flexibility.

Optionally, in the method shown in FIG. 4, the method further includes: The first node sends indication information indicating the node type of the first node. Specifically, the first node may further send the indication information indicating the node type of the first node, so that another node clearly determines the node type of the first node based on the indication information, and can subsequently interact with the first node based on the node type of the first node.

Optionally, in the method shown in FIG. 4, before step S401, the first node determines the node type of the first node based on capability information and/or requirement information; or the first node receives the indication information indicating the node type of the first node. Specifically, the first node may clearly determine the node type of the first node based on the capability information and/or the requirement information of the first node, or may clearly determine the node type of the first node based on an indication of the another node, to improve the solution implementation flexibility.

For example, the following further describes the foregoing three node types and implementation processes thereof with reference to some implementation examples.

The node L may be referred to as a local training node. Such a node has a knowledge sharing capability and/or requirement, and has no knowledge absorption capability and/or requirement. In addition, the node has local data, which may be used for local training.

The node A may be referred to as a model merging node. Such a node has no knowledge sharing capability/requirement, but has a knowledge absorption capability and/or requirement. In addition, the node may have no local data used for local training.

The node H may be referred to as a hybrid function node. Such a node has both a knowledge sharing capability/requirement and a knowledge absorption capability and/or requirement. In addition, the node has local data, which may be used for local training.

Optionally, similar to the foregoing configuration manners for the local AI model and the public AI model, a node type may be determined by a node based on a capability, a requirement, and a local data status of the node, or may be specified by the management node, or may be determined in a preconfiguration manner.

In addition, after the node type is determined, the node needs to notify a neighboring node of the node type (that is, role information) of the node, that is, role interaction. Furthermore, the node may further notify the neighboring node of the node type together with information about a learning task type participated in. For example, after each node receives a node type sent by a neighboring node, an implementation of constructing a neighboring node information table may be shown in Table 1.

TABLE 1

| Node ID | Neighboring node type | Task type | Link quality indicator |
|---|---|---|---|
| ID 1 | L | Type 1 | |

. . .

| | | |
|---|---|---|
| ID n | H | Type k |

In the neighboring node information table shown in Table 1, the node ID is a unique identifier of the neighboring node in the decentralized learning system, and may be allocated uniformly when the neighboring node joins the learning system. A role of the neighboring node is determined by the node type sent by the neighboring node. The task type indicates a type of a learning task participated in by the neighboring node, such as CSI compression, beam management, and positioning. The task type may also be determined by the node type sent by the neighboring node. The link quality indicator describes quality of a communication link between a specified neighboring node and a current node, and may include indicators such as a signal-to-noise ratio (SNR), a throughput, a delay, and a packet loss rate of the communication link.

In some embodiments, a role of each node is not constant. In a learning process (e.g. a learning system running process), when a communication network topology, a node requirement, an environment status, or the like changes, a role of a node may change. As shown in FIG. 5b, an example in which roles of some nodes change is provided.

For example, a node H cannot obtain new local data, or disables a knowledge sharing function based on privacy or other considerations and changes to a node A.

For another example, the node H determines that a local AI model with relatively good performance can be obtained through training based on the local data, disables a knowledge absorption function, and changes to a node L.

For another example, the node L cannot obtain new local data, disables a local training function, enables the knowledge absorption function, and changes to a node A.

For another example, the node L determines that a local AI model with satisfactory performance cannot be obtained through training based on the local data, enables the knowledge absorption function, and changes to the node H.

For another example, the node A can obtain the local data, enables the local training function, and changes to the node H.

For another example, the node A can obtain the local data, determines that a local AI model with relatively good performance can be obtained through training based on the local data, disables the knowledge absorption function, and changes to the node L.

Similar to the implementation process in Table 1, after the role of each node changes, the neighboring node may be notified of the change, so that the neighboring node updates the neighboring node information table maintained by the neighboring node.

In an implementation mode, for any node, after the neighboring node information table is constructed, each node starts to perform a related operation based on its role and perform distributed learning. The learning process is performed periodically. Each periodicity is divided into two phases: model update and model interaction. Table 2 provides operations of different nodes in each phase.

TABLE 2

| | Model update | Model interaction |
|---|---|---|
| Node | 1. Train and update a local AI model | Send the public AI model and auxiliary |
| L | based on local data. | information to a neighboring node. |
| | 2. Obtain (Update) a public AI model | |
| | based on the local AI model. | |
| Node | Perform merging based on the public AI | 1. Receive the public AI model and the |
| A | model and the auxiliary information that | auxiliary information that are sent by the |
| | are sent by the neighboring node to | neighboring node. |
| | obtain a merged (updated) local AI | 2. Send the public AI model and the |
| | model and determine the public AI | auxiliary information after the public AI |
| | model. | model is determined. |
| Node | 1. Train and update a local AI model | 1. Receive the public AI model and the |
| H | based on local data. | auxiliary information that are sent by the |
| | 2. Perform model merging based on the | neighboring node. |
| | public AI model and the auxiliary | 2. Send the public AI model and the |
| | information that are sent by the | auxiliary information after the public AI |
| | neighboring node and a local AI model | model is determined. |
| | to obtain a merged (updated) local AI | |
| | model and determine the public AI | |
| | model. | |

In the foregoing operations, the local training and update of the model may be implemented by using gradient reverse transfer training similar to that used in the fully-connected neural network described in FIG. 2a, or may be implemented by using another AI training process. In addition, for a method for obtaining a public AI model based on a local AI model and updating the local AI model based on the public AI model, refer to the descriptions in FIG. 5a and related descriptions.

As can be learned from the foregoing implementation process, when the first AI model indicated by the first information sent by the first node is obtained based on a second AI model, the second AI model may be obtained by the first node based on local data; or the second AI model may be obtained by the first node based on K pieces of information, where each of the K pieces of information indicates model information of an AI model of another node and auxiliary information of the AI model of the another node, and K is a positive integer; or the second AI model may be obtained by the first node based on the local data and the K pieces of information. Specifically, the second AI model used to obtain the first AI model may be any one of the foregoing implementations to improve solution implementation flexibility.

Optionally, a value of K is 1 less than a value of M, or a value of K is less than M−1.

In some embodiments, the auxiliary information of the first AI model includes at least one of the following: type information of the first AI model, identification information of the first node, identification information of a receiving node of the first AI model, version information of the first AI model, time information for generating the first AI model, geographical location information for generating the first AI model, and distribution information of the local data of the first node. Specifically, the auxiliary information of the first AI model indicated by the first information includes at least one of the foregoing information, so that the receiver of the first information can perform AI model processing on the model information of the first AI model based on the at least one of the foregoing information, thereby improving performance of the AI model obtained by the receiver of the first information by performing processing based on the first AI model.

Optionally, the model information of the first AI model and the auxiliary information of the first AI model are separately carried on different transmission resources, and the transmission resources include a time domain resource and/or a frequency domain resource. Specifically, because a data volume corresponding to the model information of the first AI model and a data volume corresponding to the auxiliary information of the first AI model are generally different (for example, the data volume corresponding to the model information of the first AI model is generally greater than the data volume corresponding to the auxiliary information of the first AI model), so that the two can be separately carried on different transmission resources.

Optionally, the transmission resources are preconfigured resources.

For example, it can be learned from the foregoing description that the M nodes in the system in which the first node is located send the updated public AI model of a current node to a neighboring node (for example, the first information sent by the first node to the second node in step S402 carries the model information of the first AI model). Because a structure and a quantity of parameters of the public AI model are preset and unified, a communication mechanism with relatively low complexity may be designed. With more implementation instances, the following describes an implementation process of sending the first information by the first node in step S402.

For the first information sent by the first node in step S402, the first AI model indicated by the first information may be a public AI model. The first node may pack the first information into a data packet in a manner shown in FIG. 5c. The model information of the public AI model is carried in a payload, and the auxiliary information of the public AI model is carried in a packet header. As shown in FIG. 5c, the packet header includes at least one of information such as a payload type, a node ID, a version number, a timestamp, a geographical location, and data distribution.

Optionally, the payload type indicates a type of public AI model information carried in the payload. The type may be a model parameter, a model gradient, an (intermediate) inference result, or the like. A bit mapping table may be designed to implicitly indicate the information. For example, 00 indicates the model parameter, 11 indicates the model gradient, and 01 or 10 indicates the (intermediate) inference result.

Optionally, the node ID may include a source node ID and a destination node ID. The node ID is the same as the node ID used in the neighboring node information table. The source node ID identifies the node generating the public AI model information included in the payload. The destination node ID identifies a destination node of the public AI model information included in the payload.

Optionally, the version number indicates a version of the public AI model included in the payload, and a design of the version number is specifically discussed in Embodiment 2.

Optionally, the timestamp is a time at which update of the public AI model included in the payload is completed.

Optionally, the geographical location identifies information about a geographical location at which the node is located when the public AI model included in the payload is updated.

Optionally, the data distribution is distribution information of local data of the source node, and this field may be empty (or filled with 0) for a data packet generated by a node without local data. Information such as the version number, the timestamp, the geographical location, or the data distribution is used for model merging, and therefore is collectively referred to as model merging auxiliary information.

For a process of sending the first information, the first node may send a data packet to the neighboring node in step S402 after packaging of the data packet in the foregoing manner. For example, a communication link between the first node and the second node is a sidelink, that is, the sidelink sends a data packet.

Optionally, a packet header and a payload of the data packet may be sent separately. For example, the packet header is sent on a control channel, and the payload is sent on a data channel. In this case, the control channel in which the packet header is located further needs to send a transmission resource (e.g. a time-frequency-space resource) location of the data channel used to send the payload corresponding to the packet header. Because the structure and the quantity of parameters of the public AI model are preset and unified, a quantity of transmission resources used by the public AI model is also predictable and constant. Therefore, a resource dedicated to public AI model transmission may be pre-allocated, thereby simplifying a design of a communication mechanism (that is, a transmission resource allocation and scheduling policy does not need to be separately determined based on different data packet lengths).

S403: The second node performs model processing based on N pieces of first information to obtain a target AI model.

In this embodiment, after the second node receives the N pieces of first information in step S402, the second node performs model processing based on the N pieces of first information in step S403 to obtain the target AI model.

Optionally, the target AI model is used to complete an AI task of the second node, or the target AI model is a local model of the second node.

In some embodiments, that the second node performs model processing based on the N pieces of first information to obtain a target AI model includes: The second node performs model processing based on the N pieces of first information and a node type of the second node to obtain the target AI model. Specifically, when the target AI model is obtained based on at least the node type of the second node, the second node can perform different AI model processing processes based on different node types to resolve a problem of a single node function, thereby improving flexibility.

Optionally, a value of K is 1 less than a value of M, or a value of K is less than M−1.

For example, in step S403, after receiving data packets that are sent by N neighboring nodes and that include the public AI model information, the second node may unpack the data packets to obtain the packet header and the payload. The node merges the public AI model based on model merging auxiliary information (such as the version number, the timestamp, the geographical location, and the data distribution). Public AI model information sent by the N neighboring nodes may be grouped, and merging is performed in a multi-level merging manner. For example, public AI model information in data packets with similar timestamps is classified as one group, or public AI model information in data packets with similar geographical location information is classified as one group, or public AI model information in data packets with different data distribution is classified as one group. The model merging may be implemented by using a method such as weighted averaging or distillation.

The following describes an example of a process in which the N pieces of first information received by the second node include version number information of an AI model. The version number may be designed as AxLyHz, where A, L, and H are constant fields, and x, y, and z are integers. In addition, a version number update rule is as follows: The node L trains and updates the public AI model based on the local AI model, and the y field in the model version number is increased by 1. The node A performs merging each time after receiving the public AI model sent by the neighboring node to obtain an updated public AI model, the x field in the model version number is increased by 1, and the y and z fields are set to 0 each time the x field is increased by 1. The node H updates the public AI model based on the local AI model and the public AI model that is sent by the neighboring node, the x, y, and z fields in the model version number each are increased by 1, and the y and z fields are set to 0 each time the x field is increased by 1.

As shown in FIG. 5d, one circle represents one AI model, and identifies that a version number of a model is AxLyHz. In the example shown in FIG. 5d, a value of x may be an integer such as 1, 2, 3, or 4; a value of y may be an integer such as 0, 1, y, or u; and a value of z may be an integer such as 0, x, v, w, or z. In addition, in the version number-based model merging process shown in FIG. 5d, public AI models with similar version numbers may be classified as one group. Intra-group merging is first performed, and then grouping and intra-group merging are performed until the merging process is completed. For example, as shown in FIG. 5d, public AI models with a same x field are classified as one group. Each time intra-group merging is completed, the x field is increased by 1, and the y and z fields are reset to 0 until a fused public AI model obtained after merging is obtained.

In some embodiments, version numbers of the public models finally obtained through merging by different nodes in the system in which the second node is located are similar, or may even be the same. The purpose of the entire system is to obtain a model for each node to complete a local AI task on the node. Therefore, the version number is used only to merge models that are more similar. The performance of a model with a higher version is not necessarily better.

Similarly, the second node may further perform merging (e.g. distillation, pruning, and expansion) based on auxiliary information (such as a timestamp and a geographical location) of another AI model. For a specific implementation process, refer to the foregoing example.

In some embodiments, the process in which the second node performs model processing based on the N pieces of first information and a node type of the second node to obtain the target AI model in step S403 includes: When the node type of the second node is a node type of performing merging processing based on an AI model of another node, the second node performs model merging on N first AI models based on the N pieces of first information to obtain the target AI model. Specifically, when the node type of the second node is the node type of performing merging processing based on the AI model of the another node, after the second node receives the N pieces of first information and determines the N first AI models, the second node performs model merging on the N first AI models to obtain the target AI model.

In some embodiments, the process in which the second node performs model processing based on the N pieces of first information and a node type of the second node to obtain the target AI model in step S403 includes: When the node type of the second node is a node type of performing local training based on the local data and performing merging processing based on the AI model of the another node, the second node performs model merging on the N first AI models and a second AI model based on the N pieces of first information to obtain the target AI model, where the second AI model is obtained through training based on the local data. Specifically, when the node type of the second node is the node type of performing local training based on the local data and performing merging processing based on the AI model of the another node, after the second node receives the N pieces of first information and determines the N first AI models, the second node needs to perform training based on the local data to obtain the second AI model, and performs model merging on the N first AI models and the second AI model to obtain the target AI model.

In some embodiments, for the second AI model used by the second node, refer to related descriptions of the second AI model used by the first node, and a corresponding technical effect is implemented.

In some embodiments, the method further includes: The second node receives indication information indicating a node type of the first node. Specifically, the second node may further receive the indication information indicating the node type of the first node, so that the second node clearly determines the node type of the first node based on the indication information. Subsequently, the second node can interact with the first node based on the node type of the first node.

In some embodiments, the method further includes: The second node sends indication information indicating the node type of the second node. Specifically, the second node may further send the indication information indicating the node type of the second node, so that the another node clearly determines the node type of the second node based on the indication information, and can subsequently interact with the second node based on the node type of the second node.

In some embodiments, the method further includes: The second node determines the node type of the second node based on capability information and/or requirement information; or the second node receives the indication information indicating the node type of the second node. Specifically, the second node may clearly determine the node type of the second node based on the capability information and/or the requirement information of the second node, or may clearly determine the node type of the second node based on an indication of the another node, to improve the solution implementation flexibility.

In some embodiments, for a related implementation process (for example, determining of the node type and indication of the node type) of the node type of the second node, refer to the foregoing related descriptions of the node type of the first node, and a corresponding technical effect is implemented.

Based on the technical solution shown in FIG. 4, after the first node determines the first AI model, the first node sends the first information indicating the model information of the first AI model and the auxiliary information of the first AI model. Compared with a manner in which different nodes exchange only respective AI models, in addition to the model information of the first AI model, the first information may further indicate the auxiliary information of the first AI model, so that a receiver of the first information can perform AI model processing (for example, training and merging) on the model information of the first AI model based on the auxiliary information of the first AI model, thereby improving performance of an AI model obtained by the receiver of the first information by performing processing based on the first AI model.

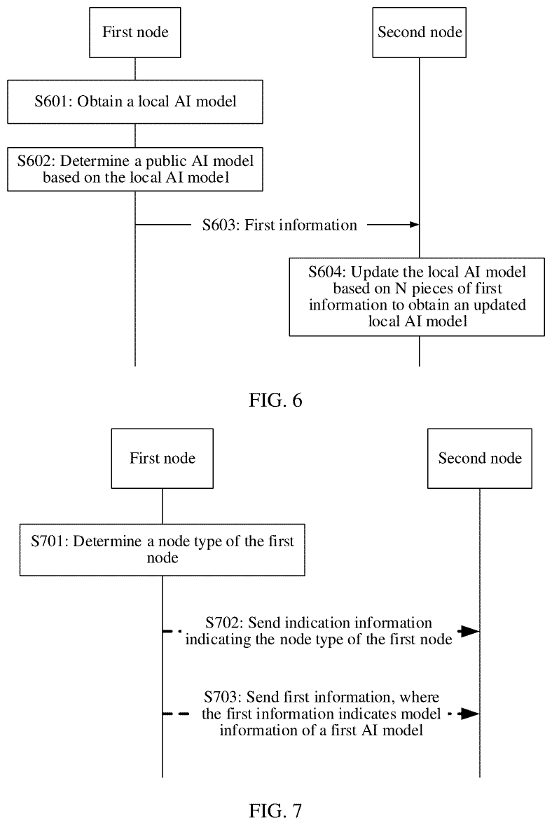

FIG. 6 is another diagram of interactions in an AI model processing method according to this disclosure. The method includes the following steps.

S601: A first node obtains a local AI model.

In this embodiment, the first node obtains the local AI model in step S601, and the local AI model is used to complete an AI task of the first node.

In some embodiments, the local AI model obtained by the first node in step S601 is obtained based on local data; or the local AI model obtained by the first node in step S601 is obtained based on K pieces of information, where each of the K pieces of information indicates model information of an AI model of another node and auxiliary information of the AI model of the another node, and K is a positive integer; or the local AI model obtained by the first node in step S601 is obtained based on the local data and the K pieces of information. Specifically, the local AI model used to obtain public AI model may be any one of the foregoing implementations to improve solution implementation flexibility.

In some embodiments, for a related implementation process (for example, configuration of the local AI model or a model processing process of the local AI model) of the local AI model obtained by the first node in step S601, refer to the descriptions in FIG. 4 and related embodiments, and a corresponding technical effect is implemented.

S602: The first node determines the public AI model based on the local AI model.

In this embodiment, after the first node obtains the local AI model in step S601, the first node determines the public AI model based on the local AI model in step S402. The public AI model is a model that can be understood by M nodes in a system in which the first node is located, and M is an integer greater than or equal to 2.

In some embodiments, the public AI model determined by the first node in step S602 is a model that can be understood by the M nodes in the system in which the first node is located. This may be expressed as that the public AI model is a model common to the M nodes in the system in which the first node is located, a model structure of the public AI model is a model structure that can be understood by the M nodes in the system in which the first node is located, or a model structure of the public AI model is a model structure common to the M nodes in the system in which the first node is located.

In some embodiments, for a related implementation process (for example, configuration of the public AI model or a model processing process of the public AI model) of the public AI model, refer to the descriptions in FIG. 4 and related embodiments, and a corresponding technical effect is implemented.

In some embodiments, the process in which the first node determines the public AI model based on the local AI model in step S602 includes: The first node determines the public AI model based on the local AI model and a node type of the first node. Specifically, the first node may determine the public AI model based on the local AI model and the node type of the first node, so that the first node can perform different AI model processing processes based on different node types to resolve a problem of a single node function, thereby improving flexibility.

In some embodiments, for a related implementation process (for example, determining of the node type and indication of the node type) of the node type of the first node, refer to the descriptions in FIG. 4 and related embodiments, and a corresponding technical effect is implemented.

Optionally, the node type includes any one of the following: a node type of performing local training based on the local data, a node type of performing merging processing based on an AI model of another node, and a node type of performing local training based on the local data and performing merging processing based on the AI model of the another node. Specifically, a node type used to obtain the public AI model may be any one of the foregoing implementations to improve solution implementation flexibility.

Optionally, in the method shown in FIG. 6, the method further includes: The first node sends indication information indicating the node type of the first node. Specifically, the first node may further send the indication information indicating the node type of the first node, so that another node clearly determines the node type of the first node based on the indication information, and can subsequently interact with the first node based on the node type of the first node.

Optionally, in the method shown in FIG. 6, the method further includes: The first node determines the node type of the first node based on capability information and/or requirement information; or the first node receives the indication information indicating the node type of the first node. Specifically, the first node may clearly determine the node type of the first node based on the capability information and/or the requirement information of the first node, or may clearly determine the node type of the first node based on an indication of the another node, to improve the solution implementation flexibility.

S603: The first node sends first information, where the first information indicates model information of the public AI model.

In this embodiment, the first node sends, in step S603, the first information indicating the model information of the public AI model. Correspondingly, for a second node, the second node receives, in step S603, N pieces of first information sent by N first nodes, where Nis a positive integer.

In some embodiments, for a related implementation process (for example, a process of packaging the first information and a process of sending the first information) of the first information, refer to the descriptions in FIG. 4 and related embodiments, and a corresponding technical effect is implemented.

S604: The second node updates the local AI model based on the N pieces of first information to obtain updated local AI model information.

In this embodiment, after the second node receives the N pieces of first information in step S603, the second node updates the local AI model based on the N pieces of first information in step S604 to obtain the updated local AI model information.

In some embodiments, the first information sent by the first node in step S603 further indicates the auxiliary information of the public AI model. Specifically, the first information sent by the first node further indicates the auxiliary information of the public AI model. Compared with a manner in which different nodes exchange only respective AI models, in addition to the model information of the public AI model, the first information may further indicate the auxiliary information of the public AI model, so that a receiver of the first information can perform AI model processing (for example, training and merging) on the model information of the public AI model based on the auxiliary information of the public AI model, thereby improving performance of an AI model obtained by the receiver of the first information by performing processing based on the public AI model.

Optionally, the auxiliary information of the public AI model includes at least one of the following: type information of the public AI model, identification information of the first node, identification information of a receiving node of the public AI model, version information of the public AI model, time information for generating the public AI model, geographical location information for generating the public AI model, and distribution information of the local data of the first node. Specifically, the auxiliary information of the public AI model indicated by the first information includes at least one of the foregoing information, so that the receiver of the first information can perform AI model processing on the model information of the public AI model based on the at least one of the foregoing information, thereby improving performance of the AI model obtained by the receiver of the first information by performing processing based on the public AI model.

Optionally, the model information of the public AI model and the auxiliary information of the public AI model are separately carried on different transmission resources, and the transmission resources include a time domain resource and/or a frequency domain resource. Specifically, because a data volume corresponding to model information of the public AI model and a data volume corresponding to auxiliary information of the public AI model are generally different (for example, the data volume corresponding to the model information of the public AI model is generally greater than the data volume corresponding to the auxiliary information of the public AI model), so that the two can be separately carried on different transmission resources.

In some embodiments, for a related implementation process of the first information (for example, a process of receiving the first information or an AI model processing process performed by the second node based on the first information), refer to the descriptions in FIG. 4 and related embodiments, and a corresponding technical effect is implemented.

In some embodiments, a process in which the second node updates the local AI model based on the N pieces of first information to obtain the updated local AI model in step S604 includes: The second node updates the local AI model based on the N pieces of first information and a node type of the second node to obtain the updated local AI model. Specifically, the second node may determine the public AI model based on the N pieces of first information and the node type of the second node, so that the second node can perform different AI model processing processes based on different node types, to resolve a problem of a single node function, thereby improving the flexibility.

Optionally, the node type includes any one of the following: a node type of performing merging processing based on the AI model of the another node and a node type of performing local training based on the local data and performing merging processing based on the AI model of the another node. Specifically, the node type used to obtain the updated local AI model may be any one of the foregoing implementations to improve the solution implementation flexibility.

Optionally, when the node type is the node type of performing merging processing based on the AI model of the another node, the local AI model is obtained based on P pieces of information, each of the P pieces of information indicates model information of the AI model of the another node and auxiliary information of the AI model of the another node, and P is a positive integer.

Optionally, when the node type is the node type of performing local training based on the local data and performing merging processing based on the AI model of the another node, the local AI model is obtained based on the local data (for example, in the first iterative processing process), or the local AI model is obtained based on the local data and the P pieces of information (for example, in another iterative processing process other than the first iterative processing process), each of the P pieces of information indicates the model information of the AI model of the another node and the auxiliary information of the AI model of the another node, and P is a positive integer.

Specifically, when the node types are different, the local AI model may be the foregoing different implementations to improve the solution implementation flexibility.

Optionally, the method further includes: The second node sends indication information indicating the node type of the second node. Specifically, the second node may further send the indication information indicating the node type of the second node, so that the another node clearly determines the node type of the second node based on the indication information, and can subsequently interact with the second node based on the node type of the second node.

Optionally, the method further includes: The second node determines the node type of the second node based on capability information and/or requirement information; or the second node receives the indication information indicating the node type of the second node. Specifically, the second node may clearly determine the node type of the second node based on the capability information and/or the requirement information of the second node, or may clearly determine the node type of the second node based on an indication of the another node, to improve the solution implementation flexibility.

In some embodiments, for a related implementation process (for example, determining of the node type and indication of the node type) of the node type of the second node, refer to the descriptions in FIG. 4 and related embodiments, and a corresponding technical effect is implemented.

Based on the technical solution shown in FIG. 6, the first node obtains the local AI model used to complete the AI task of the first node, the first node determines the public AI model based on the local AI model, and the first node sends the first information indicating the model information of the public AI model. The public AI model is a model that can be understood by the M nodes in the system in which the first node is located. In other words, the public AI model indicated by the first information sent by the first node is a model that can be understood by the M nodes in the system in which the first node is located, so that when the M nodes are of a plurality of different node types, another node can understand the first AI model and further perform model processing after receiving the first information.

FIG. 7 is another diagram of interactions in an AI model processing method according to this disclosure. The method includes the following steps.

S701: A first node determines a node type of a first node.

In this embodiment, the first node determines the node type of the first node in step S701, and the first node performs at least one of step S702 and step S703 after step S701.

In some embodiments, if the first node performs step S702 and step S703 after step S701, an execution sequence of step S702 and step S703 is not limited in this disclosure. For example, step S702 is performed before step S703, or step S703 is performed before step S702.

In some embodiments, the node type determined by the first node in step S701 includes any one of the following: a node type of performing local training based on the local data, a node type of performing merging processing based on the AI model of the another node, and a node type of performing local training based on the local data and performing merging processing based on the AI model of the another node. Specifically, a node type used to obtain the first AI model may be any one of the foregoing implementations to improve solution implementation flexibility.

Optionally, the method further includes: The first node determines the node type of the first node based on capability information and/or requirement information; or the first node receives indication information indicating the node type of the first node. Specifically, the first node may clearly determine the node type of the first node based on the capability information and/or the requirement information of the first node, or may clearly determine the node type of the first node based on an indication of the another node, to improve the solution implementation flexibility.

S702: The first node sends the indication information indicating the node type of the first node.

In this embodiment, after the first node determines the node type of the first node in step S701, the first node sends, in step S702, the indication information indicating the node type of the first node. Correspondingly, the second node receives, in step S702, the indication information indicating the node type of the first node.

Specifically, the first node may further send the indication information indicating the node type of the first node, so that another node clearly determines the node type of the first node based on the indication information, and can subsequently interact with the first node based on the node type of the first node.

In some embodiments, for a related implementation process (for example, determining of the node type and indication of the node type) of the node type of the first node, refer to the descriptions in FIG. 4 and related embodiments, and a corresponding technical effect is implemented.

S703: The first node sends first information, where the first information indicates model information of the first AI model.

In this embodiment, after the first node determines the node type of the first node in step S701, the first node determines the first AI model based on the node type of the first node, and the first node sends, in step S703, the first information indicating the model information of the first AI model. Correspondingly, the second node receives, in step S703, N pieces of first information sent by N first nodes.

In some embodiments, the first AI model indicated by the first information sent by the first node may be a model obtained by the first node based on the node type of the first node. When the first AI model is obtained based on at least the node type of the first node, the first node can perform different AI model processing processes based on different node types to resolve a problem of a single node function, thereby improving the flexibility.

Optionally, the first AI model indicated by the first information sent by the first node may be a model obtained by the first node based on the node type of the first node and a second AI model. When the first AI model is obtained based on at least the second AI model, the first AI model indicated by the first information sent by the first node may be a model that can be understood by another node, so that the another node performs further model processing after receiving the first AI model.

Optionally, the second AI model is obtained based on the local data; or the second AI model is obtained based on K pieces of information, each of the K pieces of information indicates model information of an AI model of the another node and auxiliary information of the AI model of the another node, and K is a positive integer; or the second AI model is obtained based on the local data and the K pieces of information. Specifically, the second AI model used to obtain the first AI model may be any one of the foregoing implementations to improve solution implementation flexibility.

Optionally, the first information further indicates auxiliary information of the first AI model. Specifically, the first information sent by the first node further indicates the auxiliary information of the first AI model. Compared with a manner in which different nodes exchange only respective AI models, in addition to the model information of the first AI model, the first information may further indicate the auxiliary information of the first AI model, so that a receiver of the first information can perform AI model processing (for example, training and merging) on the model information of the first AI model based on the auxiliary information of the first AI model, thereby improving performance of an AI model obtained by the receiver of the first information by performing processing based on the first AI model.

Optionally, the auxiliary information of the first AI model includes at least one of the following: type information of the first AI model, identification information of the first node, identification information of a receiving node of the first AI model, version information of the first AI model, time information for generating the first AI model, geographical location information for generating the first AI model, and distribution information of the local data of the first node. Specifically, the auxiliary information of the first AI model indicated by the first information includes at least one of the foregoing information, so that the receiver of the first information can perform AI model processing on the model information of the first AI model based on the at least one of the foregoing information, thereby improving performance of the AI model obtained by the receiver of the first information by performing processing based on the first AI model.

Optionally, the model information of the first AI model and the auxiliary information of the first AI model are separately carried on different transmission resources, and the transmission resources include a time domain resource and/or a frequency domain resource. Specifically, because a data volume corresponding to model information of the public AI model and a data volume corresponding to auxiliary information of the public AI model are generally different (for example, the data volume corresponding to the model information of the public AI model is generally greater than the data volume corresponding to the auxiliary information of the public AI model), so that the two can be separately carried on different transmission resources.

Optionally, the first AI model is a model that can be understood by M nodes in a system in which the first node is located, and M is an integer greater than or equal to 2. Specifically, the first AI model indicated by the first information sent by the first node is a model that can be understood by the M nodes in the system in which the first node is located, so that when the M nodes are of a plurality of different node types, the another node can understand the first AI model and further perform model processing after receiving the first information.

In some embodiments, for a related implementation process of the first information (for example, a process of packaging the first information, a process of sending the first information, a process of receiving the first information or an AI model processing process performed by the second node based on the first information), refer to the descriptions in FIG. 4 and related embodiments, and a corresponding technical effect is implemented.

Based on the technical solution shown in FIG. 7, the first node may determine the node type of the first node. Subsequently, the first node may perform AI model processing based on the node type. In this way, the first node can perform different AI model processing processes based on different node types to resolve a problem of a single node function, thereby improving flexibility.

Refer to FIG. 8. An embodiment of this disclosure provides a communication apparatus 800. The communication apparatus 800 can implement a function of the first node (where the first node is a terminal device or a network device) in the foregoing method embodiments, and therefore, can also implement the beneficial effects of the foregoing method embodiments. In this embodiment of this disclosure, the communication apparatus 800 may be the first node, or may be an integrated circuit or an element in the first node, for example, a chip. In the following embodiment, an example in which the communication apparatus 800 is the first node is used for description.

In some embodiments, when the apparatus 800 is configured to perform the method performed by the first node in any one of the foregoing embodiments, the apparatus 800 includes a processing unit 801 and a transceiver unit 802. The processing unit 801 is configured to determine a first AI model. The transceiver unit 802 is configured to send first information, where the first information indicates model information of the first AI model and auxiliary information of the first AI model.

In some embodiments, the auxiliary information of the first AI model includes at least one of the following:
type information of the first AI model, identification information of the first node, identification information of a receiving node of the first AI model, version information of the first AI model, time information for generating the first AI model, geographical location information for generating the first AI model, and distribution information of local data of the first node.

In some embodiments, the model information of the first AI model and the auxiliary information of the first AI model are separately carried on different transmission resources, and the transmission resources include a time domain resource and/or a frequency domain resource.

In some embodiments, the first AI model is obtained based on a node type of the first node.

In some embodiments, the first AI model is obtained based on a second AI model and the node type of the first node.

In some embodiments, the second AI model is obtained based on local data; or the second AI model is obtained based on K pieces of information, each of the K pieces of information indicates model information of an AI model of another node and auxiliary information of the AI model of the another node, and K is a positive integer; or the second AI model is obtained based on the local data and the K pieces of information.

In some embodiments, the node type includes any one of the following: a node type of performing local training based on the local data, a node type of performing merging processing based on an AI model of another node, and a node type of performing local training based on the local data and performing merging processing based on the AI model of the another node.

In some embodiments, the transceiver unit 802 is further configured to send the indication information indicating the node type of the first node.

In some embodiments, the processing unit 801 is further configured to determine the node type of the first node based on capability information and/or requirement information; or the transceiver unit 802 is further configured to receive the indication information indicating the node type of the first node.

In some embodiments, the first AI model is a model that can be understood by M nodes in a system in which the first node is located, and M is an integer greater than or equal to 2.

In some embodiments, when the apparatus 800 is configured to perform the method performed by the second node in any one of the foregoing embodiments, the apparatus 800 includes a processing unit 801 and a transceiver unit 802. The transceiver unit 802 is configured to receive N pieces of first information, where each of the N pieces of first information indicates model information of a first AI model and auxiliary information of the first AI model, and N is a positive integer. The processing unit 801 is configured to perform model processing based on the N pieces of first information to obtain a target AI model.

Optionally, the target AI model is used to complete an AI task of the second node, or the target AI model is a local model of the second node.

In some embodiments, the auxiliary information of the first AI model includes at least one of the following: type information of first AI model, identification information of the first node, identification information of a receiving node of the first AI model, version information of the first AI model, time information for generating the first AI model, geographical location information for generating the first AI model, and distribution information of the local data of the first node.

In some embodiments, the model information of the first AI model and the auxiliary information of the first AI model are separately carried on different transmission resources, and the transmission resources include a time domain resource and/or a frequency domain resource.

In some embodiments, the processing unit 801 is specifically configured to perform model processing based on the N pieces of first information and a node type of the second node to obtain the target AI model.

In some embodiments, when the node type of the second node is a node type of performing merging processing based on an AI model of another node, the processing unit 801 is specifically configured to perform model merging on N first AI models based on the N pieces of first information to obtain the target AI model.

In some embodiments, when the node type of the second node is a node type of performing local training based on the local data and performing merging processing based on the AI model of the another node, the processing unit 801 is specifically configured to perform model merging on the N first AI models and a second AI model based on the N pieces of first information to obtain the target AI model, where the second AI model is obtained through training based on the local data.

In some embodiments, the transceiver unit 802 is further configured to receive the indication information indicating the node type of the first node.

In some embodiments, the transceiver unit 802 is further configured to send indication information indicating the node type of the second node.

In some embodiments, the processing unit 801 is further configured to determine the node type of the second node based on capability information and/or requirement information; or the transceiver unit 802 is further configured to receive the indication information indicating the node type of the second node.

In some embodiments, the first AI model is a model that can be understood by M nodes in a system in which the second node is located, and M is an integer greater than or equal to 2.

In some embodiments, when the apparatus 800 is configured to perform the method performed by the first node in any one of the foregoing embodiments, the apparatus 800 includes a processing unit 801 and a transceiver unit 802. The processing unit 801 is configured to obtain a local AI model, where the local AI model is used to complete an AI task of the first node. The processing unit 801 is further configured to determine a public AI model based on the local AI model, where the public AI model is a model that can be understood by M nodes in a system in which the first node is located, and M is an integer greater than or equal to 2. The transceiver unit 802 is configured to send first information, where the first information indicates model information of the public AI model.

In some embodiments, the processing unit 801 is specifically configured to determine the public AI model based on the local AI model and a node type of the first node.

In some embodiments, the node type includes any one of the following: a node type of performing local training based on the local data, a node type of performing merging processing based on an AI model of another node, and a node type of performing local training based on the local data and performing merging processing based on the AI model of the another node.

In some embodiments, the transceiver unit 802 is further configured to send the indication information indicating the node type of the first node.

In some embodiments, the processing unit 801 is further configured to determine the node type of the first node based on capability information and/or requirement information; or the transceiver unit 802 is further configured to receive the indication information indicating the node type of the first node.

In some embodiments,
the local AI model is obtained based on the local data; or
the local AI model is obtained based on K pieces of information, each of the K pieces of information indicates model information of an AI model of another node and auxiliary information of the AI model of the another node, and K is a positive integer; or
the local AI model is obtained based on the local data and the K pieces of information.

In some embodiments, the first information further indicates auxiliary information of the public AI model.

In some embodiments, the auxiliary information of the public AI model includes at least one of the following:
type information of the public AI model, identification information of the first node, identification information of a receiving node of the public AI model, version information of the public AI model, time information for generating the public AI model, geographical location information for generating the public AI model, and distribution information of the local data of the first node.

In some embodiments, the model information of the public AI model and the auxiliary information of the public AI model are separately carried on different transmission resources, and the transmission resources include a time domain resource and/or a frequency domain resource.

In some embodiments, when the apparatus 800 is configured to perform the method performed by the second node in any one of the foregoing embodiments, the apparatus 800 includes a processing unit 801 and a transceiver unit 802. The transceiver unit 802 is configured to receive N pieces of first information, where each of the N pieces of first information indicates model information of a public AI model, the public AI model is a model that can be understood by M nodes in a system in which the first node is located, and M is an integer greater than or equal to 2. The processing unit 801 is configured to update a local AI model based on the N pieces of first information to obtain an updated local AI model, where the local AI model is used to complete an AI task of the second node.

In some embodiments, the processing unit 801 is specifically configured to update the local AI model based on the N pieces of first information and a node type of the second node to obtain the updated local AI model.

In some embodiments, the node type includes any one of the following: a node type of performing merging processing based on an AI model of another node and a node type of performing local training based on the local data and performing merging processing based on the AI model of the another node.

In some embodiments, the transceiver unit 802 is further configured to send indication information indicating the node type of the second node.

In some embodiments, the processing unit 801 is further configured to determine the node type of the second node based on capability information and/or requirement information; or the transceiver unit 802 is further configured to receive the indication information indicating the node type of the second node.

In some embodiments, when the node type is the node type of performing merging processing based on the AI model of the another node, the local AI model is obtained based on P pieces of information, each of the P pieces of information indicates model information of the AI model of the another node and auxiliary information of the AI model of the another node, and P is a positive integer.

In some embodiments, when the node type is the node type of performing local training based on the local data and performing merging processing based on the AI model of the another node, the local AI model is obtained based on the local data, or the local AI model is obtained based on the local data and the P pieces of information, each of the P pieces of information indicates the model information of the AI model of the another node and the auxiliary information of the AI model of the another node, and P is a positive integer.

In some embodiments, the first information further indicates auxiliary information of the public AI model.

In some embodiments, the auxiliary information of the public AI model includes at least one of the following: type information of the public AI model, identification information of the first node, identification information of a receiving node of the public AI model, version information of the public AI model, time information for generating the public AI model, geographical location information for generating the public AI model, and distribution information of the local data of the first node.

In some embodiments, the model information of the public AI model and the auxiliary information of the public AI model are separately carried on different transmission resources, and the transmission resources include a time domain resource and/or a frequency domain resource.

In some embodiments, when the apparatus 800 is configured to perform the method performed by the first node in any one of the foregoing embodiments, the apparatus 800 includes a processing unit 801 and a transceiver unit 802. The processing unit 801 is used by the first node to determine the node type of the first node.

In some embodiments, the apparatus further includes the transceiver unit. The transceiver unit 802 is configured to send indication information indicating the node type of the first node.

In a possible implementation, the apparatus further includes the transceiver unit 802. The transceiver unit 802 is configured to send first information, where the first information indicates model information of the first AI model, and the first AI model is obtained based on the node type of the first node.

Optionally, the first AI model is obtained based on a second AI model and the node type of the first node.

In some embodiments,
the second AI model is obtained based on local data; or
the second AI model is obtained based on K pieces of information, each of the K pieces of information indicates model information of an AI model of the another node and auxiliary information of the AI model of the another node, and K is a positive integer; or
the second AI model is obtained based on the local data and the K pieces of information.

In some embodiments, the node type includes any one of the following: a node type of performing local training based on the local data, a node type of performing merging processing based on an AI model of another node, and a node type of performing local training based on the local data and performing merging processing based on the AI model of the another node.

In some embodiments, the first information further indicates auxiliary information of the first AI model. The auxiliary information of the first AI model includes at least one of the following: type information of the first AI model, identification information of the first node, identification information of a receiving node of the first AI model, version information of the first AI model, time information for generating the first AI model, geographical location information for generating the first AI model, and distribution information of the local data of the first node.

In some embodiments, the model information of the first AI model and the auxiliary information of the first AI model are separately carried on different transmission resources, and the transmission resources include a time domain resource and/or a frequency domain resource.

In some embodiments, the first AI model is a model that can be understood by M nodes in a system in which the first node is located, and M is an integer greater than or equal to 2.

In some embodiments, the processing unit 801 is further configured to determine the node type of the first node based on capability information and/or requirement information; or the transceiver unit 802 is further configured to receive the indication information indicating the node type of the first node.

In some embodiments, when the apparatus 800 is configured to perform the method performed by the second node in any one of the foregoing embodiments, the apparatus 800 includes the transceiver unit 802. The transceiver unit 802 is used by the second node to receive indication information indicating the node type of the first node; and/or the transceiver unit 802 is configured to receive first information, where the first information indicates the model information of the first AI model, and the first AI model is obtained based on the node type of the first node.

Optionally, the first AI model is obtained based on a second AI model and the node type of the first node.

In some embodiments,
the second AI model is obtained based on local data; or
the second AI model is obtained based on K pieces of information, each of the K pieces of information indicates model information of an AI model of the another node and auxiliary information of the AI model of the another node, and K is a positive integer; or
the second AI model is obtained based on the local data and the K pieces of information.

In some embodiments, the node type includes any one of the following: a node type of performing local training based on the local data, a node type of performing merging processing based on an AI model of another node, and a node type of performing local training based on the local data and performing merging processing based on the AI model of the another node.

In some embodiments, the first information further indicates auxiliary information of the first AI model. The auxiliary information of the first AI model includes at least one of the following: type information of the first AI model, identification information of the first node, identification information of a receiving node of the first AI model, version information of the first AI model, time information for generating the first AI model, geographical location information for generating the first AI model, and distribution information of the local data of the first node.

In some embodiments, the model information of the first AI model and the auxiliary information of the first AI model are separately carried on different transmission resources, and the transmission resources include a time domain resource and/or a frequency domain resource.

In some embodiments, the first AI model is a model that can be understood by M nodes in a system in which the first node is located, and M is an integer greater than or equal to 2.

In some embodiments, the apparatus further includes the processing unit 801. The processing unit 801 is configured to determine a node type of the second node based on capability information and/or requirement information; or the transceiver unit is further configured to receive indication information indicating the node type of the second node.

In some embodiments, for specific content such as an information execution process of the units of the communication apparatus 800, refer to descriptions in the foregoing method embodiments of this disclosure.

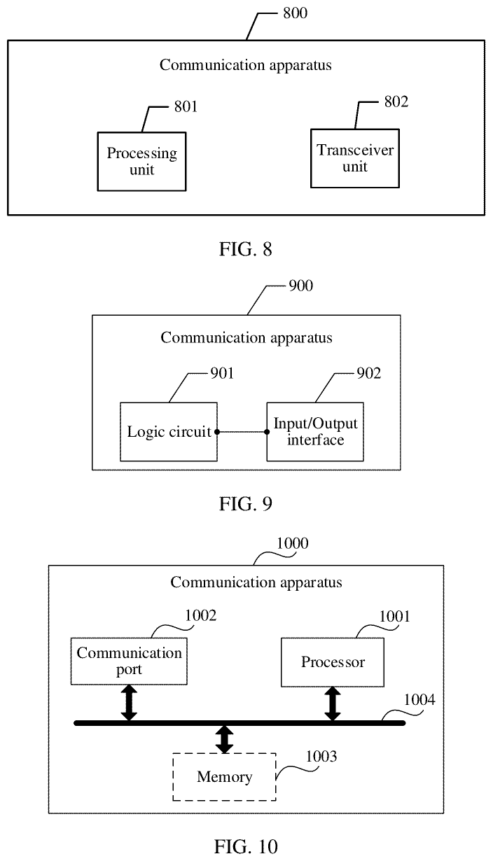

FIG. 9 is another diagram of a structure of a communication apparatus 900 according to this disclosure. The communication apparatus 900 includes at least an input/output interface 902. The communication apparatus 900 may be a chip or an integrated circuit.

Optionally, the communication apparatus further includes a logic circuit 901.

The transceiver unit 802 shown in FIG. 8 may be a communication interface. The communication interface may be the input/output interface 902 in FIG. 9. The input/output interface 902 may include an input interface and an output interface. Alternatively, the communication interface may be a transceiver circuit, and the transceiver circuit may include an input interface circuit and an output interface circuit.

Optionally, the logic circuit 901 is configured to determine a first AI model; and the input/output interface 902 is configured to send first information, where the first information indicates model information of the first AI model and auxiliary information of the first AI model.

Optionally, the input/output interface 902 is configured to receive N pieces of first information, where each of the N pieces of first information indicates the model information of the first AI model and the auxiliary information of the first AI model; and the logic circuit 901 is configured to perform model processing based on the N pieces of first information to obtain a target AI model.

Optionally, the logic circuit 901 is configured to obtain a local AI model, where the local AI model is used to complete an AI task of a first node. The logic circuit 901 is configured to determine a public AI model based on the local AI model, where the public AI model is a model that can be understood by M nodes in a system in which the first node is located, and M is an integer greater than or equal to 2. The input/output interface 902 is configured to send first information, where the first information indicates model information of the public AI model.

Optionally, the input/output interface 902 is configured to receive N pieces of first information, where each of the N pieces of first information indicates the model information of the public AI model, and the public AI model is a model that can be understood by the M nodes in the system in which the first node is located, and M is an integer greater than or equal to 2. The logic circuit 901 is configured to update the local AI model based on the model information of the public AI model to obtain an updated local AI model, where the local AI model is used to complete an AI task of a second node.

Optionally, the logic circuit 901 is used by the first node to determine a node type of the first node.

Optionally, the input/output interface 902 is used by the second node to receive indication information indicating the node type of the first node.

Optionally, the input/output interface 902 is configured to receive first information, where the first information indicates model information of the first AI model, and the first AI model is obtained based on the node type of the first node.

The logic circuit 901 and the input/output interface 902 may further perform other steps performed by a network device in any embodiment, and implement corresponding beneficial effects.

In some embodiments, the processing unit 801 shown in FIG. 8 may be the logic circuit 901 in FIG. 9.

Optionally, the logic circuit 901 may be a processing apparatus. Some or all functions of the processing apparatus may be implemented by using software.

Optionally, the processing apparatus may include a memory and a processor. The memory is configured to store a computer program. The processor reads and executes the computer program stored in the memory to perform corresponding processing and/or steps in any method embodiment.

Optionally, the processing apparatus may include only a processor. The memory configured to store the computer program is located outside the processing apparatus. The processor is connected to the memory through a circuit/wire to read and execute the computer program stored in the memory. The memory and the processor may be integrated together, or may be physically independent of each other.

Optionally, the processing apparatus may be one or more chips or one or more integrated circuits. For example, the processing apparatus may be one or more field-programmable gate arrays (FPGA), application-specific integrated circuits (ASIC), system on chips (SoC), central processor units (CPU), network processors (NP), digital signal processors (DSP), micro controller units (MCU), programmable logic devices (PLD) or other integrated chips, or any combination of the foregoing chips or processors.

FIG. 10 shows a communication apparatus 1000 in the foregoing embodiment according to an embodiment of this disclosure. The communication apparatus 1000 may be specifically the communication apparatus used as the terminal device in the foregoing embodiment. In the example shown in FIG. 10, the terminal device is implemented by using a terminal device (or a component in a terminal device).

In a possible diagram of a logical structure of the communication apparatus 1000, the communication apparatus 1000 may include but is not limited to at least one processor 1001 and a communication port 1002.

Further, optionally, the apparatus may further include at least one of a memory 1003 and a bus 1004. In this embodiment of this disclosure, the at least one processor 1001 is configured to control an action of the communication apparatus 1000.

In addition, the processor 1001 may be a central processing unit, a general-purpose processor, a digital signal processor, an application-specific integrated circuit, a field-programmable gate array or another programmable logic device, a transistor logic device, a hardware component, or any combination thereof. The processor may implement or execute various example logical blocks, modules, and circuits described with reference to content disclosed in this disclosure. Alternatively, the processor may be a combination of processors implementing a computing function, for example, a combination of one or more microprocessors or a combination of a digital signal processor and a microprocessor. A person skilled in the art can clearly understand that for convenient and brief description, for detailed working processes of the foregoing system, apparatus, and unit, refer to corresponding processes in the foregoing method embodiments.

In some embodiments, the communication apparatus 1000 shown in FIG. 10 may be specifically configured to implement steps implemented by the terminal device in the foregoing method embodiments, and implement technical effects corresponding to the terminal device. For a specific implementation of the communication apparatus shown in FIG. 10, refer to the descriptions in the foregoing method embodiments.

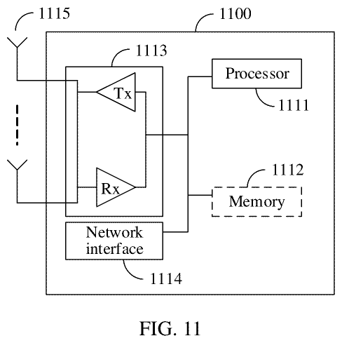

FIG. 11 is a diagram of a structure of a communication apparatus 1100 in the foregoing embodiment according to an embodiment of this disclosure. The communication apparatus 1100 may be specifically the communication apparatus used as the network device in the foregoing embodiment. In the example shown in FIG. 11, the network device is implemented by using a network device (or a component in a network device). For a structure of the communication apparatus, refer to the structure shown in FIG. 11.

The communication apparatus 1100 includes at least one processor 1111 and at least one network interface 1114. Further, optionally, the communication apparatus further includes at least one memory 1112, at least one transceiver 1113, and one or more antennas 1115. The processor 1111, the memory 1112, the transceiver 1113, and the network interface 1114 are connected, for example, connected through a bus. In this embodiment of this disclosure, the connection may include various types of interfaces, transmission lines, buses, or the like. The antenna 1115 is connected to the transceiver 1113. The network interface 1114 is configured to enable the communication apparatus to communicate with another communication device through a communication link. For example, the network interface 1114 may include a network interface between the communication apparatus and a core network device, for example, an SI interface. The network interface may include a network interface between the communication apparatus and another communication apparatus (for example, another network device or core network device), for example, an X2 or Xn interface.

The processor 1111 is mainly configured to: process a communication protocol and communication data, control the entire communication apparatus, execute a software program, and process data of the software program, for example, is configured to support the communication apparatus in performing actions described in embodiments. The communication apparatus may include a baseband processor and a central processing unit. The baseband processor is mainly configured to process the communication protocol and the communication data. The central processing unit is mainly configured to: control the entire terminal device, execute the software program, and process the data of the software program. Functions of the baseband processor and the central processing unit may be integrated into the processor 1111 in FIG. 11. A person skilled in the art may understand that the baseband processor and the central processing unit each may be an independent processor, and are interconnected by using a technology such as a bus. A person skilled in the art may understand that the terminal device may include a plurality of baseband processors to adapt to different network standards, and the terminal device may include a plurality of central processing units to enhance a processing capability of the terminal device, and components of the terminal device may be connected by using various buses. The baseband processor may also be expressed as a baseband processing circuit or a baseband processing chip. The central processing unit may also be expressed as a central processing circuit or a central processing chip. A function of processing the communication protocol and the communication data may be built in the processor, or may be stored in the memory in a form of a software program, and the processor executes the software program to implement a baseband processing function.

The memory is mainly configured to store the software program and data. The memory 1112 may exist independently, and is connected to the processor 1111. Optionally, the memory 1112 may be integrated with the processor 1111, for example, integrated into a chip. The memory 1112 can store program code for executing the technical solutions in embodiments of this disclosure, and the processor 1111 controls the execution. Various types of executed computer program code may also be considered as a driver of the processor 1111.

FIG. 11 merely shows one memory and one processor. In an actual terminal device, there may be a plurality of processors and a plurality of memories. The memory may also be referred to as a storage medium, a storage device, or the like. The memory may be a storage element on a same chip as the processor, that is, an on-chip storage element, or may be an independent storage element.

The transceiver 1113 may be configured to support receiving or sending of a radio frequency signal between the communication apparatus and the terminal. The transceiver 1113 may be connected to the antenna 1115. The transceiver 1113 includes a transmitter Tx and a receiver Rx. Specifically, the one or more antennas 1115 may receive a radio frequency signal. The receiver Rx of the transceiver 1113 is configured to: receive the radio frequency signal from the antenna, convert the radio frequency signal into a digital baseband signal or a digital intermediate frequency signal, and provide the digital baseband signal or the digital intermediate frequency signal to the processor 1111, so that the processor 1111 performs further processing, for example, demodulation and decoding, on the digital baseband signal or the digital intermediate frequency signal. In addition, the transmitter Tx of the transceiver 1113 is further configured to: receive a modulated digital baseband signal or digital intermediate frequency signal from the processor 1111, convert the modulated digital baseband signal or digital intermediate frequency signal into a radio frequency signal, and send the radio frequency signal through the one or more antennas 1115. Specifically, the receiver Rx may selectively perform one-level or multi-level down frequency mixing and analog-to-digital conversion on the radio frequency signal to obtain the digital baseband signal or the digital intermediate frequency signal. A sequence of the down frequency mixing and the analog-to-digital conversion is adjustable. The transmitter Tx may selectively perform one-level or multi-level up frequency mixing and digital-to-analog conversion on the modulated digital baseband signal or digital intermediate frequency signal to obtain the radio frequency signal. A sequence of the up frequency mixing and the digital-to-analog conversion is adjustable. The digital baseband signal and the digital intermediate frequency signal may be collectively referred to as a digital signal.

The transceiver 1113 may also be referred to as a transceiver unit, a transceiver machine, a transceiver apparatus, or the like. Optionally, a device configured to implement a receiving function in the transceiver unit may be considered as a receiving unit, and a device configured to implement a sending function in the transceiver unit may be considered as a sending unit. In other words, the transceiver unit includes a receiving unit and a sending unit. The receiving unit may also be referred to as a receiver, an input port, a receiving circuit, or the like. The sending unit may be referred to as a transmitter machine, a transmitter, a transmission circuit, or the like.

In some embodiments, the communication apparatus 1100 shown in FIG. 11 may be specifically configured to: implement steps implemented by the network device in the foregoing method embodiments, and implement technical effects corresponding to the network device. For a specific implementation of the communication apparatus 1100 shown in FIG. 11, refer to the descriptions in the foregoing method embodiments.

An embodiment of this disclosure further provides a computer-readable storage medium storing one or more computer-executable instructions. When the computer-executable instructions are executed by a processor, the processor performs the method in the possible implementations of the terminal device in the foregoing embodiments.

An embodiment of this disclosure further provides a computer-readable storage medium storing one or more computer-executable instructions. When the computer-executable instructions are executed by a processor, the processor performs the method in the possible implementations of the network device in the foregoing embodiments.

An embodiment of this disclosure further provides a computer program product (or referred to as a computer program) storing one or more computer instructions. When the computer program product is executed by a processor, the processor performs the method in the possible implementations of the foregoing terminal device.

An embodiment of this disclosure further provides a computer program product storing one or more computer inst. When the computer program product is executed by a processor, the processor performs the method in the possible implementations of the foregoing network device.

An embodiment of this disclosure further provides a chip system. The chip system includes at least one processor, configured to support a communication apparatus in implementing functions in the possible implementations of the foregoing communication apparatus. Optionally, the chip system further includes an interface circuit, and the interface circuit provides program instructions and/or data for the at least one processor. In a possible implementation, the chip system may further include a memory. The memory is configured to store program instructions and data that are necessary for the communication apparatus. The chip system may include a chip, or may include a chip and another discrete component. The communication apparatus may be specifically the terminal device in the foregoing method embodiments.

An embodiment of this disclosure further provides a chip system. The chip system includes at least one processor, configured to support a communication apparatus in implementing functions in the possible implementations of the foregoing communication apparatus. Optionally, the chip system further includes an interface circuit, and the interface circuit provides program instructions and/or data for the at least one processor. In a possible implementation, the chip system may further include a memory. The memory is configured to store program instructions and data that are necessary for the communication apparatus. The chip system may include a chip, or may include a chip and another discrete component. The communication apparatus may be specifically the network device in the foregoing method embodiments.

An embodiment of this disclosure further provides a communication system. The network system architecture includes the first node and the second node in any one of the foregoing embodiments. The first node may be a terminal device or a network device, and the second node may also be a terminal device or a network device.

In the several embodiments provided in this disclosure, the disclosed system, apparatus, and method may be implemented in other manners. For example, the apparatus embodiments described above are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electronic form, a mechanical form, or another form.

The units described as separate parts may or may not be physically separate, and parts displayed as units may or may not be physical units, and may be located at one location, or may be distributed on a plurality of network units. Some or all of the units may be selected based on actual requirements to achieve the objectives of the solutions of embodiments.

In addition, functional units in embodiments of this disclosure may be integrated into one processing unit, or each of the units may exist alone physically, or two or more units are integrated into one unit. The integrated unit may be implemented in a form of hardware, or may be implemented in a form of a software functional unit. When implemented in a form of a software functional unit and sold and used as an independent product, the integrated unit may be stored in a computer-readable storage medium. Based on such an understanding, the technical solutions of this disclosure essentially, or the part contributing to the prior art, or all or some of the technical solutions may be implemented in the form of a software product. The computer software product is stored in a storage medium and includes several instructions for instructing a computer device (which may be a personal computer, a server, or a network device) to perform all or some of the steps of the methods described in embodiments of this disclosure. The storage medium includes any medium that can store program code, such as a USB flash drive, a removable hard disk drive, a read-only memory (ROM), a random access memory (RAM), a magnetic disk, or an optical disc.

What is claimed is:

1. An artificial intelligence (AI) model processing method, comprising:
determining, by a first node, a first AI model; and
sending, by the first node, first information indicating model information of the first AI model and auxiliary information of the first AI model.

2. The method according to claim 1, wherein the auxiliary information of the first AI model comprises one or more of:
type information of the first AI model,
identification information of the first node,
identification information of a receiving node of the first AI model,
version information of the first AI model,
time information for generating the first AI model,
geographical location information for generating the first AI model, or
distribution information, of local data, of the first node.

3. The method according to claim 1, wherein the model information, of the first AI model, is carried on a first transmission resource, and the auxiliary information, of the first AI model, is carried on a second transmission resource.

4. The method according to claim 1, wherein the first AI model is associated with a node type of the first node.

5. The method according to claim 4, wherein the first AI model is associated with a second AI model and the node type of the first node; and
the second AI model is associated with one or more of:
local data;
K pieces of information, wherein each of the K pieces of information indicates model information of an AI model of another node and auxiliary information of the AI model of the another node, and K is a positive integer; or
the local data and the K pieces of information.

6. The method according to claim 5, wherein the node type comprises one or more of:
a node type of performing local training based on the local data,
a node type of performing merging processing based on the AI model of the another node, and
a node type of performing local training based on the local data and performing merging processing based on the AI model of the another node.

7. The method according to claim 4, further comprising:
sending, by the first node, indication information indicating the node type of the first node.

8. The method according to claim 4, further comprising:
determining, by the first node, the node type of the first node based on one or more of: capability information and requirement information.

9. The method according to claim 4, further comprising:
receiving, by the first node, indication information indicating the node type of the first node.

10. The method according to claim 1, wherein the first AI model can be understood by M nodes in a system in which the first node is located, and M is an integer greater than or equal to 2.

11. A communication apparatus, comprising:
at least one logic circuit; and
an input/output interface operatively coupled to the at least one logic circuit, wherein operation of the input/output interface and the at least one logic circuit causes the communication apparatus to:
determine a first artificial intelligence (AI) model; and
output first information indicating model information of the first AI model and auxiliary information of the first AI model.

12. The communication apparatus according to claim 11, wherein the auxiliary information of the first AI model comprises one or more of:
type information of the first AI model,
identification information of a node corresponding to the communication apparatus,
identification information of a receiving node of the first AI model,
version information of the first AI model,
time information for generating the first AI model,
geographical location information for generating the first AI model, or
distribution information, of local data, of the node corresponding to the communication apparatus.

13. The communication apparatus according to claim 11, wherein the model information, of the first AI, model is carried on a first transmission resource, and the auxiliary information, of the first AI model, is carried on a second transmission resource.

14. The communication apparatus according to claim 11, wherein the first AI model is associated with a node type corresponding to the communication apparatus.

15. The communication apparatus according to claim 14, wherein
the first AI model is associated with a second AI model and the node type; and
the second AI model is associated with one or more of:
local data;
K pieces of information, wherein each of the K pieces of information indicates model information of an AI model of another node and auxiliary information of the AI model of the another node, and K is a positive integer; or
the local data and the K pieces of information.

16. The communication apparatus according to claim 15, wherein the node type comprises one or more of:
a node type of performing local training based on the local data,
a node type of performing merging processing based on the AI model of the another node, and
a node type of performing local training based on the local data and performing merging processing based on the AI model of the another node.

17. The communication apparatus according to claim 14, wherein the communication apparatus is further caused to send indication information indicating the node type corresponding to the apparatus.

18. The communication apparatus according to claim 14, wherein the communication apparatus is further caused to:
determine, based on capability information and/or requirement information, the node type of the node corresponding to the communication apparatus; or
receive indication information indicating the node type of the node corresponding to the communication apparatus.

19. The communication apparatus according to claim 11, wherein the first AI model can be understood by M nodes in a system in which the node corresponding to the communication apparatus is located, and M is an integer greater than or equal to 2.

20. A non-transitory computer-readable storage medium storing instructions that, when executed by a computer, cause the computer to provide execution comprising:
determining a first artificial intelligence (AI) model; and
sending first information indicating model information of the first AI model and auxiliary information of the first AI model.
